(19) United States
(12) Patent Application Publication
(10) Pub. No.: US 2025/0314752 A1
(43) Pub. Date: Oct. 9, 2025

(54) DISTANCE MEASURING DEVICE, DISTANCE MEASURING METHOD, AND RECORDING MEDIUM RECORDING PROGRAM

(71) Applicant: SONY GROUP CORPORATION, TOKYO (JP)

(72) Inventors: YUTA SAKURAI, TOKYO (JP); MASATOSHI YOKOKAWA, TOKYO (JP)

(21) Appl. No.: 18/862,883

(22) PCT Filed: Apr. 18, 2023
(86) PCT No.: PCT/JP2023/015406

§ 371 Date: Nov. 4, 2024

(30) Foreign Application Priority Data
May 10, 2022 (JP) 2022-077434

(51) Int. Cl. G01S 7/4865; G01S 7/481; G01S 17/10

(52) U.S. Cl. CPC G01S 7/4865; G01S 7/4816; G01S 17/10

(57) ABSTRACT

A distance measuring device according to an embodiment includes a light projecting section that emits pulsed irradiation light, a light receiving section in which a plurality of pixels each detecting incidence of a photon is arranged, an integration section that creates a first histogram for each of the pixels by using a detection signal output from each of the pixels, and a restoration section that converts the first histogram into a second histogram on the basis of a state of the light receiving section.

### FIELD

The present disclosure relates to a distance measuring device, a distance measuring method, and a recording medium recording a program.

### BACKGROUND

In recent years, a distance image sensor (hereinafter, also referred to as a ToF sensor) that measures a distance by a time-of-flight (ToF) method has attracted attention. For example, there is a ToF sensor that is manufactured using a complementary metal oxide semiconductor (CMOS) semiconductor integrated circuit technology and measures a distance to an object using a plurality of planarly arranged single photon avalanche diodes (SPADs).

In the ToF sensor using the SPAD, the time (hereinafter, referred to as flight time) from when a light source emits light to when reflected light (hereinafter, referred to as echo) enters the SPAD is measured a plurality of times as a physical quantity, and the distance to the object is specified on the basis of a histogram of the physical quantity generated from the measurement result.

### CITATION LIST

### Patent Literature

Patent Literature 1: Japanese Translation of PCT International Application Publication No. 2016-533140

### SUMMARY

### Technical Problem

In the ToF sensor that acquires a light amount of echo from the object as a histogram for each flight time as described above, there is a possibility that a difference occurs between a photon amount actually incident on the SPAD and a signal output from the SPAD, and distance measurement accuracy is reduced.

Therefore, the present disclosure proposes a distance measuring device, a distance measuring method, and a recording medium in which a program is recorded, which can suppress a decrease in distance measurement accuracy.

### Solution to Problem

In order to solve the above problem, a distance measuring device according to one embodiment of the present disclosure includes: a light projecting section that emits pulsed irradiation light; a light receiving section in which a plurality of pixels each detecting incidence of a photon is arranged; an integration section that creates a first histogram for each of the pixels by using a detection signal output from each of the pixels; and a restoration section that converts the first histogram into a second histogram on a basis of a state of the light receiving section.

### BRIEF DESCRIPTION OF DRAWINGS

FIG. 1 is a block diagram illustrating a schematic configuration example of a ToF sensor as a distance measuring device according to a first embodiment of the present disclosure.

FIG. 2 is a diagram for describing an optical system of the ToF sensor according to the first embodiment.

FIG. 3 is a block diagram illustrating a schematic configuration example of a light receiving section according to the first embodiment.

FIG. 4 is a schematic diagram illustrating a schematic configuration example of a SPAD array according to the first embodiment.

FIG. 5 is a circuit diagram illustrating a schematic configuration example of a SPAD pixel according to the first embodiment.

FIG. 6 is a timing chart for describing an operation example of a readout circuit according to the first embodiment.

FIG. 7 is a block diagram illustrating a more detailed configuration example of a SPAD addition section according to the first embodiment.

FIG. 8 is a diagram for describing an example of a laser waveform received by the SPAD array according to the first embodiment.

FIG. 9 is a diagram for describing photon detection efficiency (PDE) with respect to photon incidence of the SPAD pixel according to the first embodiment.

FIG. 10 is a diagram for describing a state of a macro pixel according to the first embodiment.

FIG. 11 is a diagram for describing a waveform of a SPAD deterioration signal output from the macro pixel according to the first embodiment.

FIG. 12 is a diagram for describing an example of a restored SPAD signal restored from the SPAD deterioration signal according to the first embodiment.

FIG. 13 is a timing chart for describing a passive recharge method.

FIG. 14 is a timing chart for describing an active recharge method.

FIG. 15 is a timing chart for describing a synchronous recharge method.

FIG. 16 is a block diagram illustrating a more detailed configuration example of the ToF sensor according to the first embodiment.

FIG. 17 is a block diagram illustrating a more detailed configuration example of a restoration section according to the first embodiment.

FIG. 18 is a diagram for describing a variation of an output mode of a detection signal output from the SPAD pixel according to the first embodiment.

FIG. 19 is a diagram for describing an example of a PDE characteristic curve of the SPAD pixel according to the first embodiment.

FIG. 20 is a diagram for describing a case where there is re-incidence of photons during a dead period in the first embodiment.

FIG. 21 is a diagram for describing an example of a relationship between an occupancy rate and a photon amount according to the first embodiment.

FIG. 22 is a diagram for describing a quantization error in the first embodiment.

FIG. 23 is a diagram for describing a standard deviation in the first embodiment.

FIG. 24 is a diagram illustrating an example of an estimated SPAD signal according to the first embodiment.

FIG. 25 is a diagram illustrating an example of a known laser waveform according to the first embodiment.

FIG. 26 is a block diagram illustrating a more detailed configuration example of an output section according to the first embodiment.

FIG. 27 is a diagram for describing an example of a feature amount extracted by a waveform feature amount output section according to the first embodiment.

FIG. 28 is a diagram for describing an example of scaling executed in a histogram compression section according to the first embodiment.

FIG. 29 is a flowchart illustrating a schematic flow example of a ToF sensor according to the first embodiment.

FIG. 30 is a block diagram illustrating a configuration example of a restoration section according to a modification of the first embodiment.

FIG. 31 is a block diagram illustrating a more detailed configuration example of the ToF sensor according to a second embodiment.

FIG. 32 is a diagram for describing an example of feedback control on a light receiving section and/or a light projecting section executed in the restoration section according to the second embodiment.

FIG. 33 is a block diagram illustrating a more detailed configuration example of a restoration section in the ToF sensor according to the third embodiment.

FIG. 34 is a diagram illustrating an example of a SPAD deterioration signal affected by rain.

FIG. 35 is a diagram illustrating an example of a SPAD deterioration signal affected by fog.

FIG. 36 is a diagram for describing an incorrect occupancy rate calculated in a case where power of a correct peak is simply linearly corrected with power of an incorrect peak while the occupancy rate remains.

FIG. 37 is a diagram for describing the operation of the mixing signal exclusion section according to the third embodiment.

FIG. 38 is a hardware configuration diagram illustrating an example of a computer according to the present disclosure.

FIG. 39 is a block diagram depicting an example of schematic configuration of a vehicle control system.

FIG. 40 is a diagram of assistance in explaining an example of installation positions of an outside-vehicle information detecting section and an imaging section.

### DESCRIPTION OF EMBODIMENTS

Hereinafter, an embodiment of the present disclosure will be described in detail with reference to the drawings. Note that, in the following embodiment, the same parts are denoted by the same reference numerals, and redundant description is omitted.

Furthermore, the present disclosure will be described according to the following order of items.
1. First Embodiment
1.1 Distance Measuring Device (ToF Sensor)
1.2 Optical System
1.3 Light Receiving Section
1.4 SPAD Array
1.5 SPAD Pixel
1.6 Schematic Operation Example of SPAD Pixel
1.7 SPAD Addition Section
1.8 Sampling Period
1.9 Signal Waveform Output from Macro Pixel
1.10 Variation of Driving Method
1.11 More Detailed Configuration Example of Distance Measuring Device (ToF Sensor)
1.12 More Detailed Configuration Example of Restoration Section
1.13 More Detailed Configuration Example of Output Section
1.14 Schematic Operation Flow Example
1.15 Summary
1.16 Modification
2. Second Embodiment
3. Third Embodiment
4. Hardware Configuration
5. Application Example

### 1. First Embodiment

First, a first embodiment will be described in detail below with reference to the drawings.

### 1.1 Distance Measuring Device (ToF Sensor)

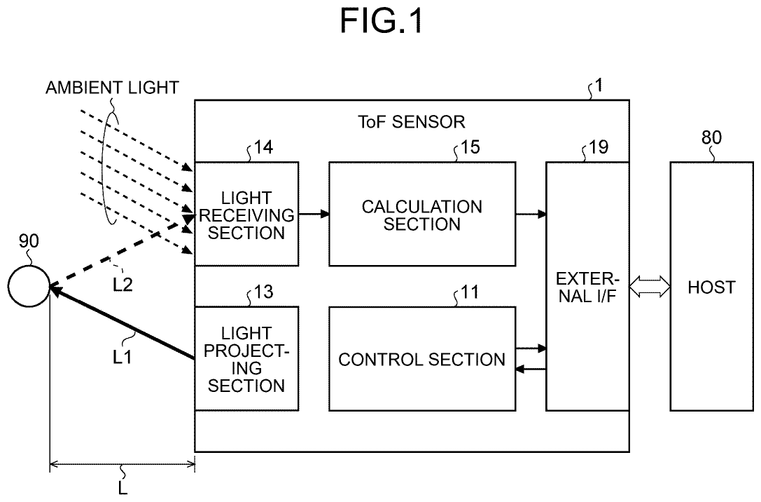

FIG. 1 is a block diagram illustrating a schematic configuration example of a ToF sensor as a distance measuring device according to the present embodiment. As illustrated in FIG. 1, the ToF sensor 1 includes a control section 11, a light projecting section 13, a light receiving section 14, a calculation section 15, and an external interface (I/F) 19.

The control section 11 includes, for example, an information processing device such as a central processing unit (CPU) and controls each section of the ToF sensor 1.

The external I/F 19 may be, for example, a communication adapter for establishing communication with an external host 80 via a communication network conforming to an arbitrary standard such as a controller area network (CAN), a local interconnect network (LIN), or FlexRay (registered trademark) in addition to a wireless local area network (LAN) or a wired LAN.

Here, for example, when the TOF sensor 1 is mounted on an automobile or the like, the host 80 may be an engine control unit (ECU) mounted on the automobile or the like. Furthermore, in a case where the ToF sensor 1 is mounted on an autonomous mobile robot such as a domestic pet robot or an autonomous mobile body such as a robot cleaner, an unmanned aerial vehicle, or a following conveyance robot, the host 80 may be a control device or the like that controls the autonomous mobile body.

The light projecting section 13 includes, for example, one or more semiconductor laser diodes as a light source, and emits pulsed laser light (also referred to as irradiation light) L1 having a predetermined time width at a predetermined cycle (also referred to as a light emission cycle). In addition, the light projecting section 13 emits the laser light L1 having a time width of 1 ns (nanosecond) at a cycle of 1 MHZ (megahertz), for example. For example, in a case where an object 90 exists within a distance measurement range, the laser light L1 emitted from the light projecting section 13 is reflected by the object 90 and enters the light receiving section 14 as reflected light L2.

Although details will be described later, the light receiving section 14 includes, for example, a plurality of SPAD pixels arranged in a two-dimensional lattice, and outputs information (corresponding to, for example, the number of detection signals to be described later) regarding the number of SPAD pixels (hereinafter, referred to as a detection number) in which incidence of photons is detected after light emission by the light projecting section 13. For example, the light receiving section 14 detects incidence of photons at a predetermined sampling period for one light emission of the light projecting section 13 and outputs the detection number thereof.

The calculation section 15 aggregates the detection number output from the light receiving section 14 for each of a plurality of SPAD pixels (for example, corresponding to one or more macro pixels to be described later), and creates a histogram in which the horizontal axis is the flight time and the vertical axis is the accumulated pixel value on the basis of the pixel value obtained by the aggregation. For example, the calculation section 15 creates a histogram in which the horizontal axis (bin of the histogram) is a sampling period corresponding to the flight time and the vertical axis is an accumulated pixel value obtained by accumulating pixel values obtained in each sampling period by repeatedly executing, for a plurality of times of light emission of the light projecting section 13, obtaining a pixel value by aggregating the detection number at a predetermined sampling frequency for one light emission of the light projecting section 13.

In addition, after performing predetermined filter processing on the created histogram, the calculation section 15 specifies the flight time when the accumulated pixel value reaches the peak from the histogram after the filter processing. Then, the calculation section 15 calculates the distance from the ToF sensor 1 or the device equipped with the ToF sensor 1 to the object 90 present within the distance measurement range on the basis of the specified flight time. Note that information of the distance calculated by the calculation section 15 may be output to the host 80 or the like via the external I/F 19, for example.

### 1.2 Optical System

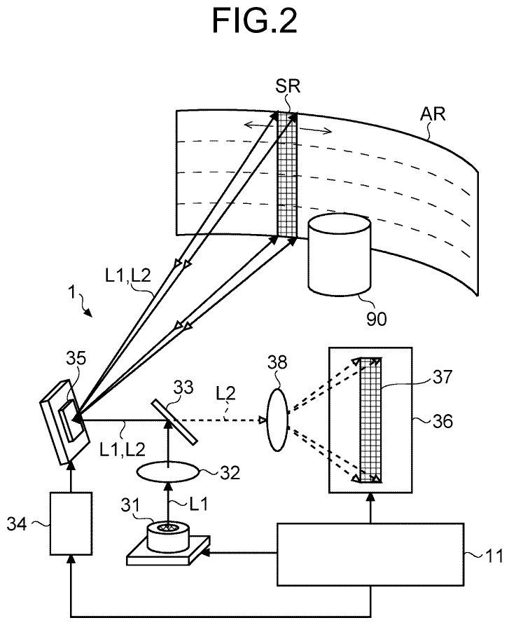

FIG. 2 is a diagram for describing an optical system of the ToF sensor according to the present embodiment. Note that, in FIG. 2, a so-called scanning type optical system in which the angle of view of the light receiving section 14 is scanned in a horizontal direction is exemplified, but it is not limited thereto, and for example, a so-called flash type ToF sensor in which the angle of view of the light receiving section 14 is fixed may be used.

As illustrated in FIG. 2, the ToF sensor 1 includes, as an optical system, a light source 31, a collimator lens 32, a half mirror 33, a galvano mirror 35, a light receiving lens 38, and a light receiving sensor 36. The light source 31, the collimator lens 32, the half mirror 33, and the galvano mirror 35 are included in the light projecting section 13 in FIG. 1, for example. Furthermore, the light receiving lens 38 and the light receiving sensor 36 are included in the light receiving section 14 in FIG. 1, for example.

In the configuration illustrated in FIG. 2, the laser light L1 emitted from the light source 31 is converted into rectangular parallel light in which an intensity spectrum of a cross section is long in a vertical direction by the collimator lens 32, and then enters the half mirror 33. The half mirror 33 reflects a part of the incident laser light L1. The laser light L1 reflected by the half mirror 33 is incident on the galvano mirror 35. For example, the galvano mirror 35 vibrates in the horizontal direction about a predetermined rotation axis by the drive section 34 that operates on the basis of the control from the control section 11. Thus, the laser light L1 is horizontally scanned so that the angle of view SR of the laser light L1 reflected by the galvano mirror 35 reciprocates in a distance measurement range AR in the horizontal direction. Note that a micro electro mechanical system (MEMS), a micromotor, or the like can be used for the drive section 34.

The laser light L1 reflected by the galvano mirror 35 is reflected by the object 90 existing in the distance measurement range AR and is incident on the galvano mirror 35 as the reflected light L2. A part of the reflected light L2 incident on the galvano mirror 35 is transmitted through the half mirror 33 and incident on the light receiving lens 38, thereby forming an image on the SPAD array 37 in the light receiving sensor 36. Note that the SPAD array 37 may be the entire light receiving sensor 36 or a part thereof.

### 1.3 Light Receiving Section

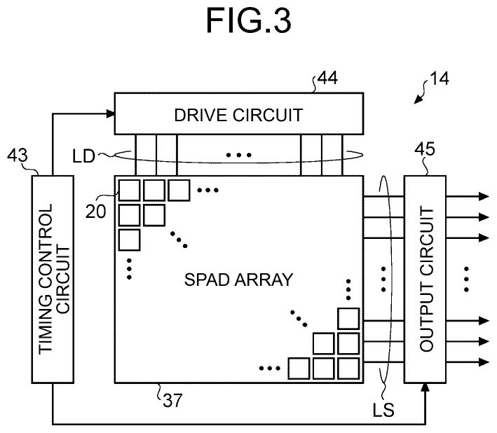

FIG. 3 is a block diagram illustrating a schematic configuration example of a light receiving section according to the present embodiment. As illustrated in FIG. 3, the light receiving section 14 includes a SPAD array 37, a timing control circuit 43, a drive circuit 44, and an output circuit 45.

The SPAD array 37 includes a plurality of SPAD pixels 20 arranged in a two-dimensional lattice pattern. To the plurality of SPAD pixels 20, a pixel drive line LD (vertical direction in the drawing) is connected for each column, and an output signal line LS (horizontal direction in the drawing) is connected for each row. One end of the pixel drive line LD is connected to an output end corresponding to each column of the drive circuit 44, and one end of the output signal line LS is connected to an input end corresponding to each row of the output circuit 45.

In the present embodiment, the reflected light L2 is detected using all or a part of the SPAD array 37. The region used in the SPAD array 37 may be a rectangle that is long in the vertical direction and is the same as the image of the reflected light L2 formed on the light receiving sensor 36 when the entire laser light L1 is reflected as the reflected light L2. However, it is not limited thereto, and various modifications such as a region larger or a region smaller than the image of the reflected light L2 formed on the SPAD array 37 may be made.

The drive circuit 44 includes a shift register, an address decoder, and the like, and drives each SPAD pixel 20 of the SPAD array 37 at the same time for all pixels, in units of columns, or the like. Therefore, the drive circuit 44 includes at least a circuit that applies a quench voltage V_QCH to be described later to each SPAD pixel 20 in the select column in the SPAD array 37 and a circuit that applies a selection control voltage V_SEL to be described later to each SPAD pixel 20 in the select column. Then, the drive circuit 44 applies the selection control voltage V_SEL to the pixel drive line LD corresponding to the column to be read, thereby selecting the SPAD pixels 20 to be used for detecting incidence of photons in units of columns.

A signal (referred to as a detection signal) V_OUT output from each SPAD pixel 20 of the column selectively scanned by the drive circuit 44 is input to the output circuit 45 through each of the output signal lines LS. The output circuit 45 outputs the detection signal V_OUT input from each SPAD pixel 20 to the SPAD addition section 50 provided for each macro pixel described later.

The timing control circuit 43 includes a timing generator or the like that generates various timing signals, and controls the drive circuit 44 and the output circuit 45 on the basis of the various timing signals generated by the timing generator.

### 1.4 SPAD Array

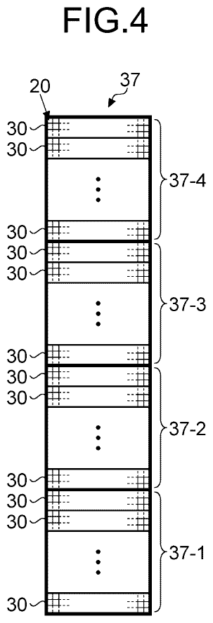

FIG. 4 is a schematic diagram illustrating a schematic configuration example of the SPAD array according to the present embodiment. As illustrated in FIG. 4, the SPAD array 37 has, for example, a configuration in which the plurality of SPAD pixels 20 is arranged in a two-dimensional lattice pattern. The plurality of SPAD pixels 20 is grouped into a plurality of macro pixels 30 including a predetermined number of SPAD pixels 20 arranged in the row and/or column direction. The shape of the region connecting outer edges of the SPAD pixels 20 located at the outermost periphery of each macro pixel 30 is a predetermined shape (for example, a rectangle).

The SPAD array 37 includes, for example, a plurality of macro pixels 30 arranged in the vertical direction (corresponding to a column direction). In the present embodiment, the SPAD array 37 is divided into a plurality of regions (hereinafter, referred to as SPAD regions) in the vertical direction, for example. In the example illustrated in FIG. 4, the SPAD array 37 is divided into four SPAD regions 37-1 to 27-4. The SPAD region 37-1 positioned at the bottom corresponds to, for example, the lowermost ¼ region in the angle of view SR of the SPAD array 37, the SPAD region 37-2 thereon corresponds to, for example, the second ¼ region from the bottom in the angle of view SR, the SPAD region 37-3 thereon corresponds to, for example, the third ¼ region from the bottom in the angle of view SR, and the uppermost SPAD region 37-4 corresponds to, for example, the uppermost ¼ region in the angle of view SR.

### 1.5 SPAD Pixel

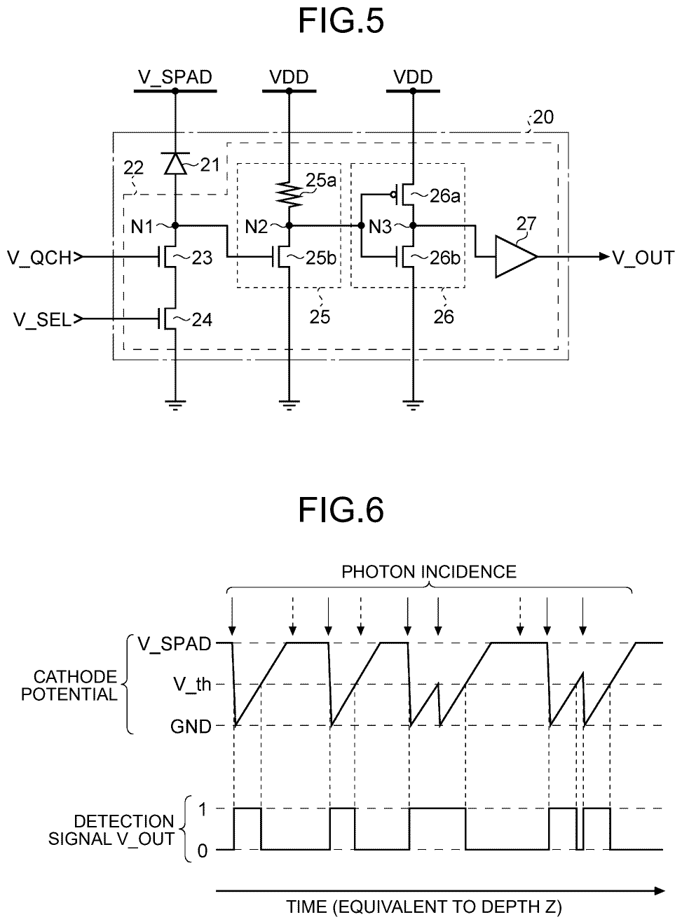

FIG. 5 is a circuit diagram illustrating a schematic configuration example of a SPAD pixel according to the present embodiment. As illustrated in FIG. 5, the SPAD pixel 20 includes a photodiode 21 as a light receiving element and a readout circuit 22 that detects incidence of a photon on the photodiode 21. When a photon enters the photodiode 21 in a state where a reverse bias voltage V_SPAD equal to or higher than a breakdown voltage (breakdown voltage) is applied between an anode and a cathode of the photodiode, an avalanche current is generated.

The readout circuit 22 includes a quench resistor 23, a digital converter 25, an inverter 26, a buffer 27, and a selection transistor 24. The quench resistor 23 is, for example, an N-type metal oxide semiconductor field effect transistor (MOSFET, hereinafter referred to as an NMOS transistor), a drain of which is connected to the anode of the photodiode 21, and a source of which is grounded via the selection transistor 24. In addition, a quench voltage V_QCH set in advance to cause the NMOS transistor to act as a quench resistor is applied from the drive circuit 44 to the gate of the NMOS transistor constituting the quench resistor 23 via the pixel drive line LD.

In the present embodiment, the photodiode 21 is a SPAD. The SPAD is an avalanche photodiode that operates in Geiger mode when a reverse bias voltage equal to or higher than a breakdown voltage (breakdown voltage) is applied between an anode and a cathode of the SPAD, and can detect incidence of one photon.

The digital converter 25 includes a resistor 25a and an NMOS transistor 25b. A drain of the NMOS transistor 25b is connected to a power supply voltage VDD via the resistor 25a, and a source thereof is grounded. In addition, a voltage at a connection point N1 between the anode of the photodiode 21 and the quench resistor 23 is applied to a gate of the NMOS transistor 25b.

The inverter 26 includes a P-type MOSFET (hereinafter, referred to as a PMOS transistor) 26a and an NMOS transistor 26b. A drain of the PMOS transistor 26a is connected to the power supply voltage VDD, and a source thereof is connected to a drain of the NMOS transistor 26b. The drain of the NMOS transistor 26b is connected to the source of the PMOS transistor 26a, and a source thereof is grounded. A voltage at a connection point N2 between the resistor 25a and the drain of the NMOS transistor 25b is applied to a gate of the PMOS transistor 26a and a gate of the NMOS transistor 26b, respectively. The output of the inverter 26 is input to the buffer 27.

The buffer 27 is a circuit for impedance conversion, and when an output signal is input from the inverter 26, the buffer converts the impedance of the input output signal and outputs the converted signal as a detection signal V_OUT.

The selection transistor 24 is, for example, an NMOS transistor, a drain of which is connected to the source of the NMOS transistor constituting the quench resistor 23, and a source of which is grounded. The selection transistor 24 is connected to the drive circuit 44, and changes from an off state to an on state when the selection control voltage V_SEL from the drive circuit 44 is applied to a gate of the selection transistor 24 via the pixel drive line LD.

### 1.6 Schematic Operation Example of SPAD Pixel

Next, an operation example of the readout circuit 22 illustrated in FIG. 5 will be described. FIG. 6 is a timing chart for describing an operation example of the readout circuit according to the present embodiment. As illustrated in FIG. 6, the readout circuit 22 operates as follows, for example. That is, first, during a period in which the selection control voltage V_SEL is applied from the drive circuit 44 to the selection transistor 24 and the selection transistor 24 is in an on state, a reverse bias voltage V_SPAD equal to or higher than a breakdown voltage V_th (breakdown voltage) is applied to the cathode of the photodiode 21. Thus, the operation of the photodiode 21 is permitted.

On the other hand, during the period in which the selection control voltage V_SEL is not applied from the drive circuit 44 to the selection transistor 24 and the selection transistor 24 is in an off state, the reverse bias voltage V_SPAD is not applied to the photodiode 21, so that the operation of the photodiode 21 is prohibited.

When a photon enters the photodiode 21 when the selection transistor 24 is in an on state, an avalanche current is generated in the photodiode 21, and the cathode potential of the photodiode 21 decreases to, for example, the ground potential GND. Thus, an avalanche current flows through the quench resistor 23, and the potential at the connection point N1 increases. When the potential at the connection point N1 becomes higher than the on-voltage of the NMOS transistor 25b, the NMOS transistor 25b is turned on, and the potential of the connection point N2 changes from the power supply voltage VDD to 0 V. Then, when the potential at the connection point N2 changes from the power supply voltage VDD to 0 V, the PMOS transistor 26a changes from an off state to an on state, the NMOS transistor 26b changes from an on state to an off state, and the potential at the connection point N3 changes from 0 V to the power supply voltage VDD. As a result, the high-level (‘1’) detection signal V_OUT is output from the buffer 27. Note that, in FIG. 6, broken arrows indicate photon incidence for which detection has failed.

Thereafter, when the potential at the connection point N1 continues to increase, the potential difference between the anode and the cathode of the photodiode 21 becomes smaller than the breakdown voltage V_th, whereby the avalanche current stops and the potential at the connection point N1 decreases. Then, when the potential at the connection point N1 becomes lower than the on-voltage of the NMOS transistor 452, the NMOS transistor 452 is turned off, and the output of the detection signal V_OUT from the buffer 27 is stopped (low level (‘0’)).

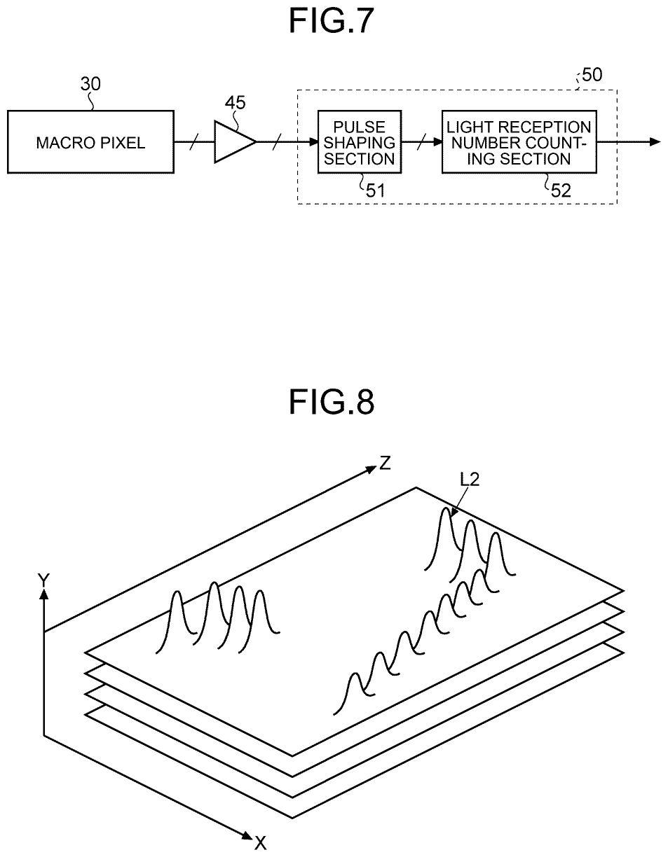

As described above, the readout circuit 22 outputs the high-level detection signal V_OUT during a period from the timing at which the photon enters the photodiode 21 to generate the avalanche current, and the NMOS transistor 452 is turned on to the timing at which the avalanche current stops and the NMOS transistor 452 is turned off. The output detection signal V_OUT is input to the SPAD addition section 50 for each macro pixel 30 via the output circuit 45 (see FIG. 7). Therefore, the detection signal V_OUT of the number (detection number) of SPAD pixels 20 in which the incidence of photons is detected among the plurality of SPAD pixels 20 constituting one macro pixel 30 is input to each SPAD addition section 50.

Note that the readout circuit 22 cannot detect the incidence of new photons on the photodiode 21 until the avalanche current stops and the potential difference between the anode and the cathode becomes equal to or larger than the breakdown voltage V_th after the avalanche current is generated by the photon incidence on the photodiode 21 and the potential difference between the anode and the cathode becomes smaller than the breakdown voltage V_th. In the present description, a period during which incidence of new photons cannot be detected is also referred to as a dead period.

### 1.7 SPAD Addition Section

FIG. 7 is a block diagram illustrating a more detailed configuration example of the SPAD addition section according to the present embodiment. Note that the SPAD addition section 50 may be included in the light receiving section 14 or may be included in the calculation section 15.

As illustrated in FIG. 7, the SPAD addition section 50 includes, for example, a pulse shaping section 51 and a light reception number counting section 52.

The pulse shaping section 51 shapes the pulse waveform of the detection signal V_OUT input from the light receiving sensor 36 via the output circuit 45 into a pulse waveform having a time width corresponding to the operation clock of the SPAD addition section 50.

The light reception number counting section 52 counts the detection signal V_OUT input from the corresponding macro pixel 30 for each sampling period, thereby counting the number (detection number) of the SPAD pixels 20 in which the incidence of photons is detected for each sampling period, and outputs the count value as the pixel value of the macro pixel 30.

### 1.8 Sampling Period

Here, the sampling period is a period of measuring a time (flight time) from when the light projecting section 13 emits the laser light L1 to when the light receiving section 14 detects incidence of photons. A period shorter than the light emission period of the light projecting section 13 is set as the sampling period. For example, by shortening the sampling period, it is possible to calculate the flight time of a photon emitted from the light projecting section 13 and reflected by the object 90 with higher time resolution. This means that the distance to the object 90 can be calculated with a higher distance measurement resolution by increasing the sampling frequency.

For example, assuming that a flight time from when the light projecting section 13 emits the laser light L1 to when the laser light L1 is reflected by the object 90 and the reflected light L2 is incident on the light receiving section 14 is t, the distance L to the object 90 can be calculated as the following Expression (1) since the light speed C is constant (C≈300 million m (meter)/s (second).

$$L = C \times t / 2 \qquad ( 1 )$$

Therefore, when the sampling frequency is 1 GHZ, the sampling period is 1 ns (nanosecond). In that case, one sampling period corresponds to 15 cm (centimeter). This indicates that the distance measurement resolution is 15 cm when the sampling frequency is 1 GHz. In addition, when the sampling frequency is 2 GHZ, which is twice the sampling frequency, the sampling period is 0.5 ns (nanoseconds), and thus one sampling period corresponds to 7.5 cm (centimeters). This indicates that the distance measurement resolution can be set to ½ when the sampling frequency is doubled. In this way, by increasing the sampling frequency and shortening the sampling period, the distance to the object 90 can be calculated more accurately.

1.9 Signal Waveform Output from Macro Pixel

Next, the waveform of the signal (hereinafter, also referred to as a SPAD deterioration signal) output from each macro pixel 30 according to the laser emission from the light projecting section 13 will be described. Note that the SPAD deterioration signal may be a histogram in which a bin number (corresponding to the Z axis) corresponds to a photon flight time (that is, the depth value (also referred to as depth information)).

FIG. 8 is a diagram for describing an example of a laser waveform received by the SPAD array according to the present embodiment. As illustrated in FIG. 8, the reflected light L2 obtained by reflecting the laser light L1 emitted from the light projecting section 13 by an object existing within the angle of view of each SPAD pixel 20 is incident on each SPAD pixel 20 of the SPAD array 37. The waveform of each reflected light L2 is substantially the same as that of the laser light L1.

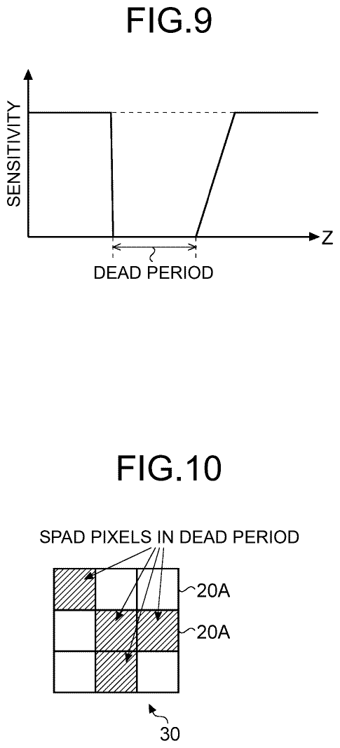

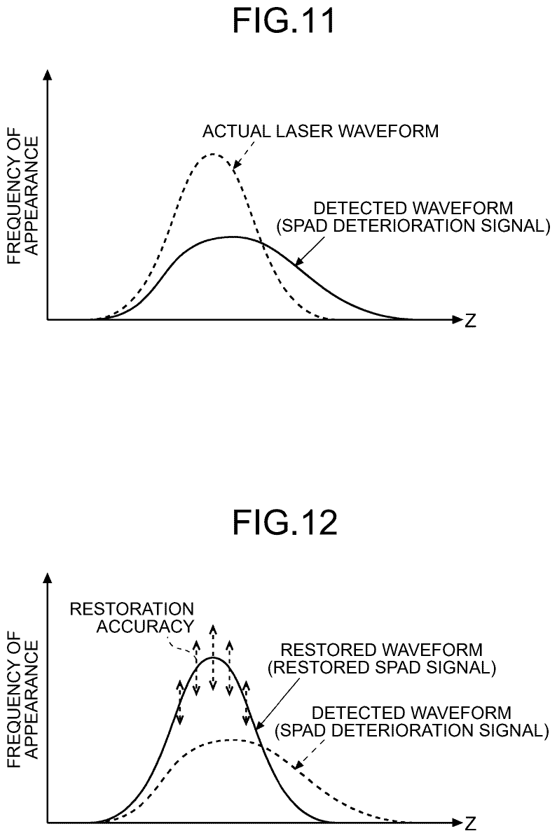

On the other hand, FIG. 9 is a diagram for describing photon detection efficiency (PDE) with respect to photon incidence of the SPAD pixel according to the present embodiment, and FIG. 10 is a diagram for describing a state of the macro pixel according to the present embodiment. Furthermore, FIG. 11 is a diagram for describing a waveform of the SPAD deterioration signal output from the macro pixel according to the present embodiment, and FIG. 12 is a diagram for describing an example of a restored SPAD signal restored from the SPAD deterioration signal according to the present embodiment. Note that the PDE is a photon detection probability, and may be sensitivity to photon incidence in units of SPAD pixels.

As described above with reference to FIG. 6, the SPAD pixel 20 has a dead period in which incidence of a new photon cannot be detected (see FIG. 9). Furthermore, as illustrated in FIG. 9, since the PDE of the SPAD pixel 20 depends on the potential difference between the anode and the cathode in the photodiode 21, the PDE gradually recovers in accordance with the increase in the cathode potential from when the cathode potential becomes equal to or higher than the breakdown voltage V_th to when the cathode potential rises to the reverse bias voltage V_SPAD (in other words, until recharging is completed,). That is, the PDE of the SPAD pixel 20 is proportional to the cathode potential.

Furthermore, among the SPAD pixels 20 constituting the macro pixel 30, the SPAD pixel 20 that has reacted to photon incidence shifts to the dead period, and thus, as illustrated in FIG. 10, the macro pixel 30 may include a SPAD pixel capable of detecting photon incidence (hereinafter, this is also referred to as an effective SPAD pixel 20A) and a SPAD pixel incapable of detecting photon incidence (hereinafter, this is also referred to as a dead SPAD pixel 20B). Therefore, the sensitivity of the macro pixel 30 to photon incidence depends on the ratio of the effective SPAD pixels 20A (also referred to as a detection effective rate) and the PDE of each effective SPAD pixel 20A. Note that the detection effective rate may be a ratio of the number of effective SPAD pixels 20A to the number of SPAD pixels 20 constituting the macro pixel 30.

Therefore, as illustrated in FIG. 11, the waveform (solid line) of the SPAD deterioration signal output from the macro pixel 30 is a deteriorated waveform having a lower peak intensity and a wider half-value width than the waveform of the actual reflected light L2 indicated by the broken line. When the waveform of the histogram is deteriorated as described above, feature amounts such as a peak position (for example, a bin number) and the center or a center position of the waveform is different from those of the original laser waveform, so that it is difficult to measure an accurate distance (that is, a depth value) to the object.

Therefore, in the present embodiment, as illustrated in FIG. 12, a laser waveform (restored SPAD signal) close to the original laser waveform or substantially equal to the original laser waveform is restored from the SPAD deterioration signal having a deteriorated waveform, thereby suppressing a decrease in the distance measurement accuracy.

Furthermore, in the present embodiment, information regarding the restoration accuracy (hereinafter, it is also simply referred to as restoration accuracy) may be added to the restored SPAD signal. By adding the restoration accuracy, it is possible to execute processing according to the restoration accuracy in the processing in the subsequent stage, and thus it is possible to further suppress a decrease in the distance measurement accuracy.

### 1.10 Variation of Driving Method

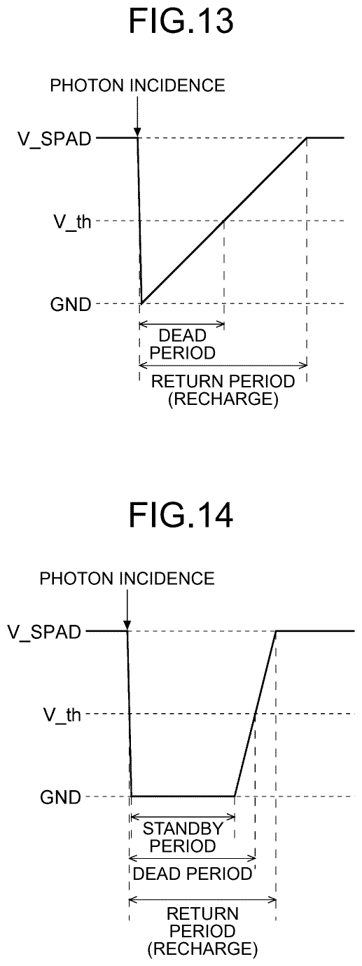

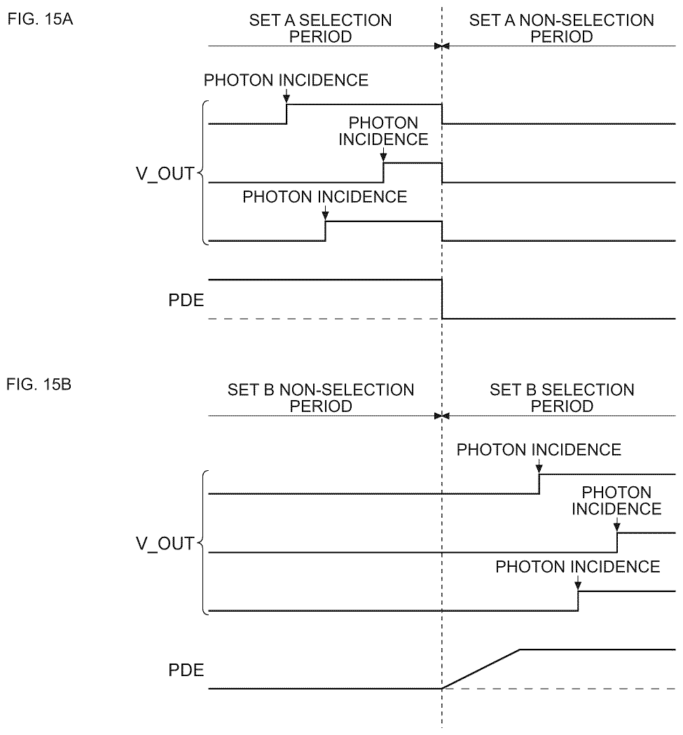

Here, a driving method of the SPAD pixel 20 will be described. As a driving method of the SPAD pixel 20, there are a passive recharge method and an active recharge method. FIG. 13 is a timing chart for describing the passive recharge method, and FIG. 14 is a timing chart for describing the active recharge method.

As illustrated in FIG. 13, the passive recharge method is a method in which the cathode potential of the photodiode 21 decreases to the ground potential GND upon detection of photon incidence, and then gradually recovers to the potential of the reverse bias voltage V_SPAD. Therefore, although the dead period can be made relatively short, the return period (that is, a period until recharging is completed) until the PDE recovers tends to be long.

On the other hand, as illustrated in FIG. 14, the active recharge method is a method in which the cathode potential of the photodiode 21 decreases to the ground potential GND upon detection of photon incidence, and then rapidly recovers to the potential of the reverse bias voltage V_SPAD after a certain standby period. Accordingly, the dead period tends to be long, but the return period until the PDE recovers can be shortened.

Furthermore, as another driving method of the SPAD pixel 20, there are a synchronous recharge method and an asynchronous recharge method. The synchronous recharge method is a method of dividing the SPAD pixel 20 included in the SPAD array 37 into two or more sets (hereinafter, also referred to as group division) and recharging the SPAD pixel 20 for each set at synchronized timing. On the other hand, the asynchronous recharge method is a method of performing recharging at independent timing for each SPAD pixel 20. Note that, in the synchronous recharge method, a selected state (also referred to as a valid state)/an unselected state (also referred to as an invalid state) of the SPAD pixel 20 for each set may be switched using, for example, the selection transistor 24.

FIG. 15 is a timing chart for describing the synchronous recharge method. Note that FIG. 15 illustrates a case where the SPAD pixels 20 included in the SPAD array 37 are divided into two sets of set A and set B.

As illustrated in (A) of FIG. 15, in a period (set A selection period) in which the SPAD pixels 20 belonging to the set A are selected, the PDE of the SPAD pixels 20 belonging to the set A is valid, and incidence of photons on the SPAD pixels 20 belonging to the set A is detected. On the other hand, as illustrated in (B) of FIG. 15, in a period (set B selection period) in which the SPAD pixels 20 belonging to the set B are selected, the PDE of the SPAD pixels 20 belonging to the set B is valid, and incidence of photons to the SPAD pixels 20 belonging to the set B is detected. Note that, in the synchronous recharge method, there is a case where the SPAD pixel 20 belonging to a newly selected set needs to be recharged when being switched from the non-selected state to the selected state, and in this case, it may take time for the PDE to rise.

### 1.11 More Detailed Configuration Example of Distance Measuring Device (ToF Sensor)

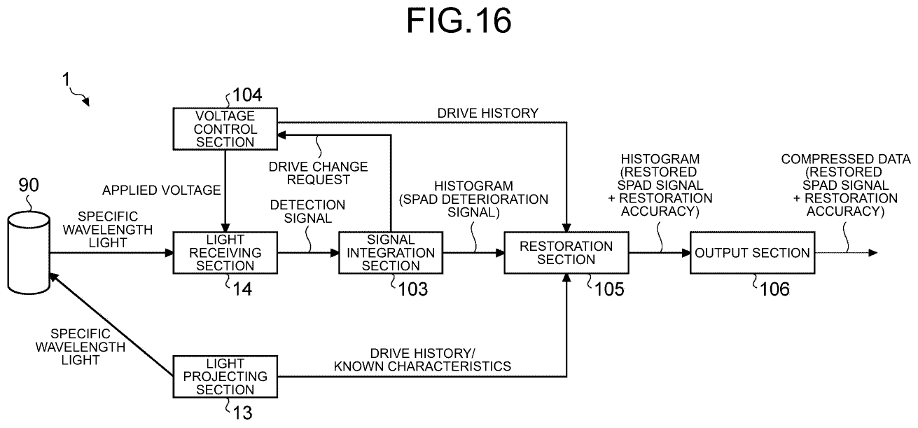

Next, a more detailed configuration example of the ToF sensor 1 according to the present embodiment will be described. FIG. 16 is a block diagram illustrating a more detailed configuration example of the ToF sensor according to the present embodiment. Note that, in FIG. 16 and the following description, for the sake of clarity, attention is paid to a configuration of a part of the ToF sensor 1 in FIG. 1. In the following description, the same components as those described above are denoted by the same reference numerals, and a detailed description thereof will be omitted.

As illustrated in FIG. 16, the ToF sensor 1 includes a light projecting section 13, a light receiving section 14, a signal integration section 103, a voltage control section 104, a restoration section 105, and an output section 106. In this configuration, the signal integration section 103, the restoration section 105, and the output section 106 may be implemented by, for example, the calculation section 15 in FIG. 1, and the voltage control section 104 may be implemented by the control section 11 in FIG. 1.

### (Signal Integration Section 103)

The detection signal V_OUT output from the light receiving section 14 is input to the signal integration section 103. The signal integration section 103 includes, for example, the SPAD addition section 50 described above, and generates a pixel value for each sampling period of each macro pixel 30 by counting the detection signal V_OUT input from the macro pixel 30 for each sampling period. Then, the signal integration section 103 integrates the generated pixel value with the value of the corresponding bin in the histogram in a memory prepared for each macro pixel 30, thereby creating a histogram in which the horizontal axis is the flight time and the vertical axis is the accumulated pixel value. Note that one bin of the histogram may correspond to, for example, one sampling period.

As described above, the histogram created by aggregating the number of detection signals V_OUT from the light receiving section 14 is a SPAD deterioration signal in which a feature amount such as a peak value or a half-value width is deteriorated as illustrated in FIG. 11. The signal integration section 103 inputs the generated SPAD deterioration signal to the restoration section 105.

### (Voltage Control Section 104)

Furthermore, the signal integration section 103 may output, to the voltage control section 104, a drive change request for adjusting (feedback control) the drive of the applied voltage (reverse bias voltage V_SPAD) and the like in the light receiving section 14 on the basis of the degree of deterioration of a peak value, a half-value width, or the like of the SPAD deterioration signal. On the other hand, the voltage control section 104 may adjust the reverse bias voltage V_SPAD applied to the cathode of the photodiode 21 of each SPAD pixel 20 in response to the input drive change request. Thus, the PDE of the SPAD pixel 20 can be improved by feedback based on the actual measurement value, so that the degree of deterioration of the SPAD deterioration signal can be reduced. As a result, it is possible to improve the SPAD signal restoration accuracy in the restoration section 105 described later.

### (Restoration Section 105)

In addition to the SPAD deterioration signal (histogram) generated by the signal integration section 103, a drive history of the light receiving section 14 from the voltage control section 104, and a drive history and known characteristics from the light projecting section 13 are input to the restoration section 105. However, it is not limited thereto, and at least known characteristics of the light projecting section 13 may be held in advance in the restoration section 105.

Note that the drive history of the light receiving section 14 may include, for example, information such as a voltage value of the reverse bias voltage V_SPAD (also referred to as a driving voltage) applied to each SPAD pixel 20 when the light receiving section 14 is driven, the timing at which the reverse bias voltage V_SPAD is applied to each SPAD pixel 20, and the timing at which the selection transistor 24 of each SPAD pixel is turned on/off.

Further, the drive history of the light projecting section 13 may include, for example, information such as laser power when the laser light L1 is emitted and an emission timing of the laser light L1.

Furthermore, the known characteristics of the light projecting section 13 may include, for example, information such as a peak intensity, a laser waveform, and a wavelength spectrum of the laser light L1 emitted from the light projecting section 13 with respect to the driving voltage of the laser light L1.

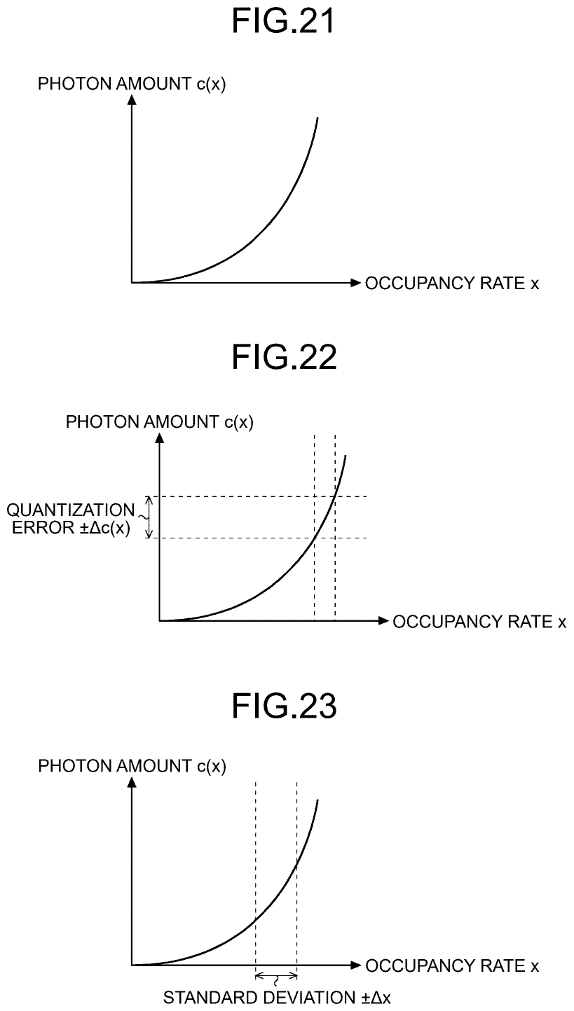

Furthermore, information such as a relationship (see FIG. 21) between the proportion (occupancy rate to be described later) of the SPAD pixels 20 (dead SPAD pixels 20B to be described later) and the photon amount in the dead period in the macro pixel 30 at each time may be input to the restoration section 105 as known characteristics. The it is not limited thereto, and the known characteristics may be held in advance in the restoration section 105.

The restoration section 105 restores the restored SPAD signal having a waveform close to the laser waveform of the original reflected light L2 (that is, laser light L1) or substantially equal to the laser waveform of the original reflected light L2 by using at least one of the input SPAD deterioration signal, the drive history of the light receiving section 14, the drive history of the light projecting section 13, or the known characteristics.

Furthermore, the restoration section 105 generates the restoration accuracy indicating how accurate the restored SPAD signal has been restored (that is, how reliable the restored SPAD signal is). The restoration accuracy may include, for example, information such as at least one of a quantization error of the value of each bin at the time of restoration or a standard deviation of the value of each bin in the restored SPAD signal (histogram), or an error range calculated from these values. However, it is not limited thereto, and for example, in a case where the restored SPAD signal is estimated using a learned model, information such as a score output from the learned model at the time of estimating the restored SPAD signal and an evaluation value calculated in an evaluation section provided for the output of the learned model may be used as the restoration accuracy.

Then, the restoration section 105 inputs the generated restored SPAD signal (histogram) and the restoration accuracy to the output section 106.

### (Output Section 106)

The output section 106 compresses the input restored SPAD signal (histogram) and the estimation accuracy as necessary and outputs the compressed SPAD signal and the estimation accuracy. The output compressed data (for example, the restored SPAD signal (histogram) after compression and the restoration accuracy) may be used for other processing in the calculation section 15, or may be output to the outside via the external I/F 19 or the like, for example.

### 1.12 More Detailed Configuration Example of Restoration Section

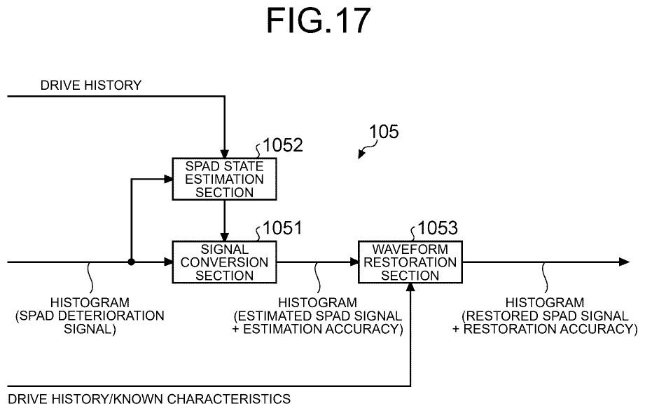

FIG. 17 is a block diagram illustrating a more detailed configuration example of the restoration section according to the present embodiment. As illustrated in FIG. 17, the restoration section 105 includes a signal conversion section 1051, a SPAD state estimation section 1052, and a waveform restoration section 1053.

### (SPAD State Estimation Section 1052)

The SPAD state estimation section 1052 estimates the state of the light receiving section 14 at each time (for example, each sampling period). The state of the light receiving section 14 may be, for example, information such as a ratio (also referred to as an occupancy rate) of the dead SPAD pixels 20B of each macro pixel 30 at each time or the PDE of each SPAD pixel 20 at each time.

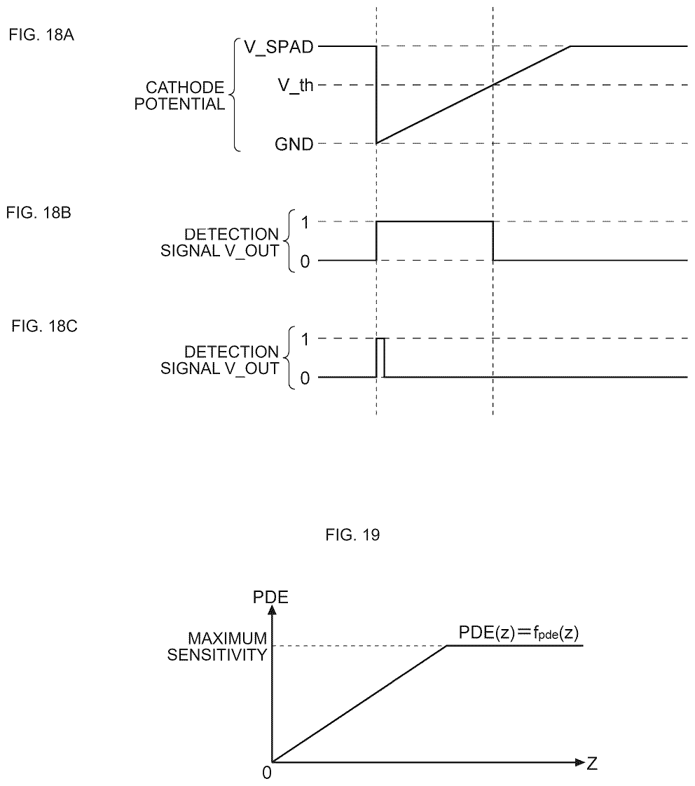

Here, in the above description using, for example, FIG. 6, as illustrated in (A) and (B) of FIG. 18, an output mode (this is also referred to as a first output mode) in which the high level (‘1’) is continuously output from the SPAD pixel 20 (specifically, the readout circuit 22) during the period in which the cathode potential of the photodiode 21 is lower than the breakdown voltage V_th has been exemplified, but the mode in which the SPAD pixel 20 outputs the high level (‘1’) is not limited thereto. For example, as illustrated in (A) and (C) of FIG. 18, it is also possible to employ an output mode (also referred to as a second output mode) in which a pulsed high level (‘1’) having a predetermined time width is output in a case where the cathode potential of the photodiode 21 is lower than the breakdown voltage V_th. The operation of the SPAD state estimation section 1052 described below can be applied to any of the above two output modes.

Accordingly, the SPAD state estimation section 1052 estimates the occupancy rate and the PDE at each time on the basis of the SPAD deterioration signal generated by the signal integration section 103 and the drive history of the light receiving section 14 from the voltage control section 104.

For example, the SPAD state estimation section 1052 may count the number of high levels from the SPAD pixels 20 during the sampling period for each of the macro pixels 30 to calculate the detection effective rate (=the number of high levels counted for each of the macro pixels 30/the number of SPAD pixels 20 constituting the macro pixels 30) of each of the macro pixels 30 at each time, and calculate the occupancy rate (=1−detection effective rate) using the calculated detection effective rate.

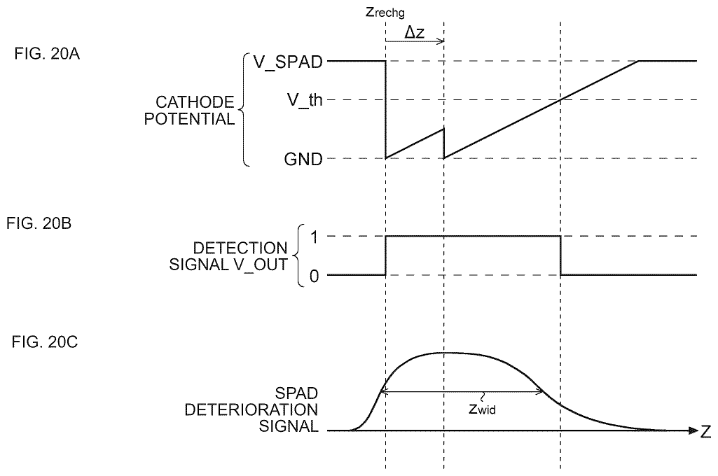

Furthermore, as illustrated in FIG. 19, the PDE of the SPAD pixel 20 during the recharge period increases in accordance with the increase in the cathode potential, and reaches the maximum sensitivity when the cathode potential reaches the reverse bias voltage V_SPAD. Therefore, from a PDE characteristic curve f_{pde} of the SPAD pixel 20 during the recharge period, the PDE (z) at the time z can be obtained as in the following Expression (2). Note that z may be a time from the start of the sampling period.

$$PDE ( z ) = {f}_{p d e} ( z ) \qquad ( 2 )$$

Then, when the time at which the photon enters the SPAD pixel 20 (the time from the start of the sampling period) is z_{rechg}, the PDE of the SPAD pixel 20 at the time z can be expressed by the following Expression (3).

$$PDE ( z ) = {f}_{p d e} ( z - {z}_{r e c h g} ) \qquad ( 3 )$$

However, as illustrated in (A) of FIG. 20, in a case where the cathode potential is lowered to the ground potential GND once and then the cathode potential is lowered to the ground potential GND again by the photon incidence again before returning to the breakdown voltage V_th or more (after Δz from z_{rechg}), as illustrated in (B), the time of the photon incidence again cannot be specified, and thus the PDE cannot be acquired from the above Expression (3).

Therefore, in the present embodiment, in order to reduce the PDE estimation error when the case as illustrated in (A) of FIG. 20 occurs, the SPAD state estimation section 1052 determines the correction amount on the basis of the feature amount (for example, a half-value width z_{wid}) of the SPAD deterioration signal (histogram) and estimates the PDE using the correction amount.

For example, in a case where the half-value width z_{wid} is a significantly large value exceeding a preset threshold, the SPAD state estimation section 1052 determines the offset Δz (z_{wid}) according to the half-value width z_{wid} as the correction amount and calculates the PDE (z) at the time z using the following Expression (4).

$$PDE ( z ) = {f}_{p d e} ( z - {z}_{r e c h g} - Δ z ( {z}_{wid} ) ) \qquad ( 4 )$$

By calculating the PDE using the correction amount in this manner, it is possible to estimate the PDE more accurately even in a case where photon incidence before completion of recharging frequently occurs, such as in a high luminance state.

### (Signal Conversion Section 1051)

In addition to the SPAD deterioration signal, the occupancy rate and the PDE at each time estimated by the SPAD state estimation section 1052 are input to the signal conversion section 1051. The signal conversion section 1051 converts the accumulated pixel value of each bin in the SPAD deterioration signal (histogram) into the number of photons (hereinafter, also referred to as photon amount) estimated to be incident at each time corresponding to each bin on the basis of at least one of the input occupancy rate or the PDE.

Here, as illustrated in FIG. 21, the occupancy rate x of each macro pixel 30 and the photon amount c(x) of each bin are in a relationship that can be approximated by an exponential function (this is defined as an exponential function f_{conv}). Therefore, the signal conversion section 1051 may convert the accumulated pixel value p(z) of each bin into the photon amount c(x) by using the following Expression (5).

$$c ( x ) = {f}_{c o n v} ( p ( z ) , PDE ( z ) , x ( z - 1 ) , x ( z ) ) \qquad ( 5 )$$

However, it is not limited to approximation by the exponential function f_{conv}, and for example, the accumulated pixel value p(z) of each bin may be converted into the photon amount c(x) using a coefficient or the like acquired in advance learning.

In addition, the signal conversion section 1051 also generates estimation accuracy when the accumulated pixel value p(z) of each bin is converted into the photon amount c(x) and the SPAD signal (hereinafter, also referred to as an estimated SPAD signal) that will be correct is estimated.

The estimation accuracy may include, for example, information such as a quantization error±Δc(x) of the value of each bin at the time of conversion as illustrated in FIG. 22, a standard deviation±Δx of the value of each bin in the estimated SPAD signal (histogram) generated by the conversion as illustrated in FIG. 23, or an error range calculated from these values. At that time, the lower limit of the error range may be determined by the following Expression (6), and the upper limit may be determined by the following Expression (7).

$$Lower limit of error range : c ( x - Δ x ) - Δ c ( x - Δ x ) \qquad ( 6 )$$

$$Upper limit of error range : c ( x + Δ x ) + Δ c ( x + Δ x ) \qquad ( 7 )$$

However, in a case where the nonlinearity of the photon amount c(x) can be ignored, the estimation accuracy may be obtained using the following approximate expression (8). Note that, in Expression (8), c′(x) is a slope (dc/dx) of a straight line drawn by the photon amount c(x).

$$Estimation accuracy = {c}^{′} Δ x + Δ c ( x ) \qquad ( 8 )$$

### (Waveform Restoration Section 1053)

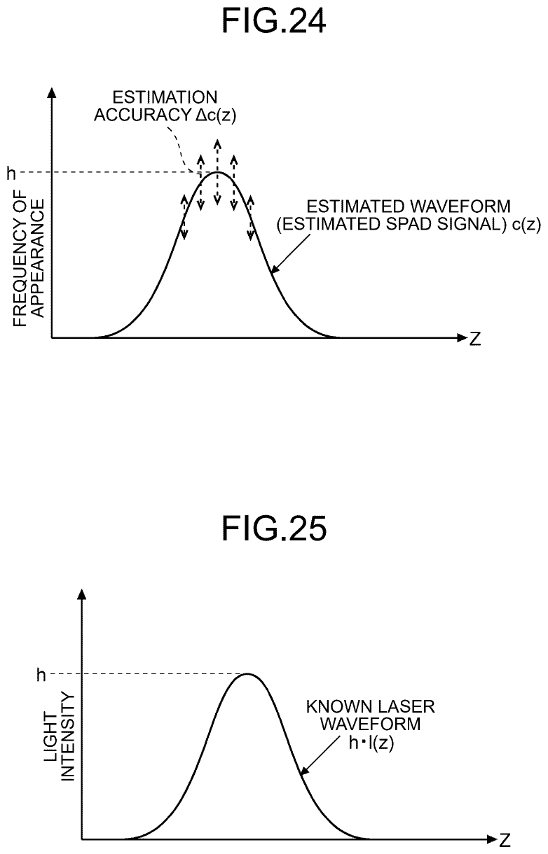

The estimated SPAD signal and the estimation accuracy estimated as illustrated in FIG. 24 are input to the waveform restoration section 1053. The drive history and the known characteristics are also input from the light projecting section 13 to the waveform restoration section 1053. The waveform restoration section 1053 corrects the value of each bin in the estimated SPAD signal on the basis of the estimated SPAD signal and the estimation accuracy input from the signal conversion section 1051 and the drive history and the known characteristics input from the light projecting section 13, thereby generating the restored SPAD signal with higher accuracy than the estimated SPAD signal. In addition, the waveform restoration section 1053 also generates the restoration accuracy when the accuracy of the estimated SPAD signal is increased.

As described above, since the signal conversion section 1051 obtains the photon amount c(x) by converting the accumulated pixel value p (x) of each bin on the basis of the occupancy rate x to generate the estimated SPAD signal, there is a possibility that the SPAD signal having a waveform close to or substantially equal to the original laser waveform has not been estimated. In addition, even if it has been estimated, the distance measurement accuracy may be further improved by bringing the laser waveform closer to the original laser waveform.

Therefore, the waveform restoration section 1053 may specify a laser waveform (hereinafter, also referred to as a known laser waveform) of the laser light L1 emitted from the light projecting section 13 on the basis of the drive history and the known characteristics (however, the known characteristics may be held in advance by the waveform restoration section 1053) input from the light projecting section 13, and generate the restored SPAD signal and the restoration accuracy with high accuracy by increasing the accuracy of the estimated SPAD signal and the estimation accuracy using the known laser waveform.

For example, as illustrated in FIG. 25, the known laser waveform h·l(z) may be generated by generating the laser waveform l(z) in which a peak value is scaled to ‘1’ from the drive history (for example, information such as laser power and emission timing) of the light projecting section 13 and the known characteristic (for example, information such as a driving voltage, a peak intensity, a laser waveform, and a wavelength spectrum), and enlarging and reducing the laser waveform l(z) in the light intensity direction (vertical axis direction) with a peak value h of the estimated SPAD signal.

In addition, as a method of increasing the accuracy of the estimated SPAD signal along the known laser waveform, for example, a weighted least squares method as illustrated in the following Expression (9) may be used. Note that the restoration waveform may be the waveform of the restored SPAD signal, and the fitting error at each time may be the restoration accuracy of the value of each bin in the restored SPAD signal after increasing the accuracy.

$$Weight according to estimation error : w ( z ) = \frac{1}{Δ c ( z )} \qquad ( 9 )$$

$$Cost function to be minimized : {e}_{total} = {min}_{h} {\sum }_{z} w ( z ) {( c ( z ) - h \cdot l ( z ) )}^{2}$$

$$Restored waveform with high accuracy : {c}^{} = {h}^{} \cdot l ( z )$$

$$Fitting error at each time : e ( z ) = c ( z ) - {c}^{} ( z )$$

The error range (restoration accuracy) after increasing the accuracy in the case of using the weighted least squares method can be determined by the following Expression (10).

$$Δ {c}^{} ( z ) = g ( {e}_{total} , e ( z ) , Δ c ( z ) ) \qquad ( 10 )$$

However, it is not limited thereto, and for example, the accuracy of the estimated SPAD signal may be increased using another method such as generating the restored PSAD signal by replacing a part or all of the estimated SPAD signal with a known laser waveform. Alternatively, in a case where the accuracy of the estimated SPAD signal is sufficiently high, the waveform restoration section 1053 may be omitted, and the estimated SPAD signal and the estimation accuracy may be output as the restored SPAD signal and the restoration accuracy.

Furthermore, the restoration accuracy is not limited to the value calculated by the above Expression (10), and may be, for example, a difference between the restored SPAD signal with high accuracy and the known laser waveform h. 1 (z) or a value calculated on the basis of the difference.

### 1.13 More Detailed Configuration Example of Output Section

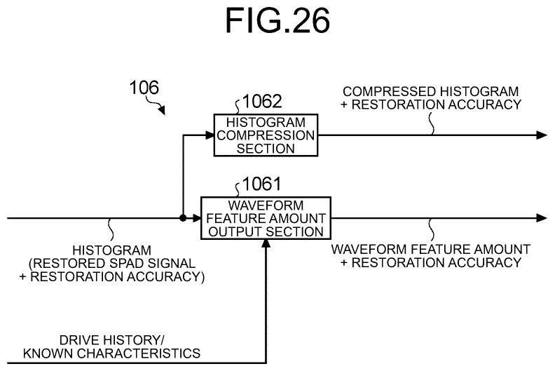

FIG. 26 is a block diagram illustrating a more detailed configuration example of the output section according to the present embodiment. As illustrated in FIG. 26, the output section 106 includes a waveform feature amount output section 1061 and a histogram compression section 1062. However, the output section 106 does not need to include both the waveform feature amount output section 1061 and the histogram compression section 1062, and may include either one or may be omitted. When it is omitted, the restored SPAD signal and the restoration accuracy output from the restoration section 105 may be output as they are.

### (Waveform Feature Amount Output Section 1061)

The waveform feature amount output section 1061 extracts a feature amount from the restored SPAD signal, and outputs the extracted feature amount and the restoration accuracy as compressed data.

For example, the waveform feature amount output section 1061 may specify one or more feature points in the restored SPAD signal by comparing the restored SPAD signal with the known laser waveform, and output information (feature amount) of the specified feature point and restoration accuracy (error range or the like) at each feature point as compressed data. At this time, the specified feature point may be, for example, a peak point (bin number or the like) of the restored SPAD signal. Furthermore, the feature amount may be information such as a peak value or a half-value width.

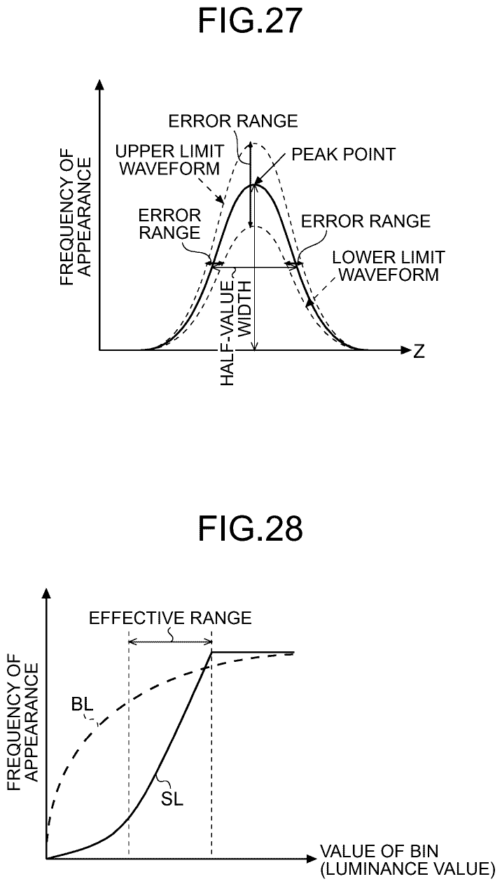

Furthermore, as illustrated in FIG. 27, the waveform feature amount output section 1061 may obtain the upper limit (upper limit waveform) and the lower limit (lower limit waveform) of the approximate waveform so that the photon amount c(z)±Δc(z) including the error falls within for each specified feature point, and output the range sandwiched between the upper limit waveform and the lower limit waveform as the restoration accuracy (error range).

### (Histogram Compression Section 1062)

The histogram compression section 1062 may generate a compressed histogram by compressing the value (photon amount) of each bin in the restored SPAD signal and output the compressed histogram and the restoration accuracy as compressed data.

For example, as illustrated in FIG. 28, in a case where the value of each bin in the restored SPAD signal is returned to the occupancy rate, as indicated by a broken line BL, the resolution in the range effective in the distance measurement is low, and there is a case where sufficient distance measurement accuracy cannot be obtained. Therefore, as indicated by a solid line SL in FIG. 28, the histogram compression section 1062 may compress the restored SPAD signal by rescaling the occupancy rate obtained from the value of each bin in the restored SPAD signal so that sufficient accuracy can be obtained in the effective range.

In addition, in a case where the value of each bin in the restored SPAD signal is expressed by the number of bits more than necessary, the histogram compression section 1062 may compress the restored SPAD signal by executing the bit reduction processing. For example, in a case where the value of each bin in the restored SPAD signal is expressed by 32 bits, whereas the peak value of the restored SPAD signal is less than 8 bits, the histogram compression section 1062 may reduce the value of each bin in the restored SPAD signal from 32 bits to 8 bits.

### 1.14 Schematic Operation Flow Example

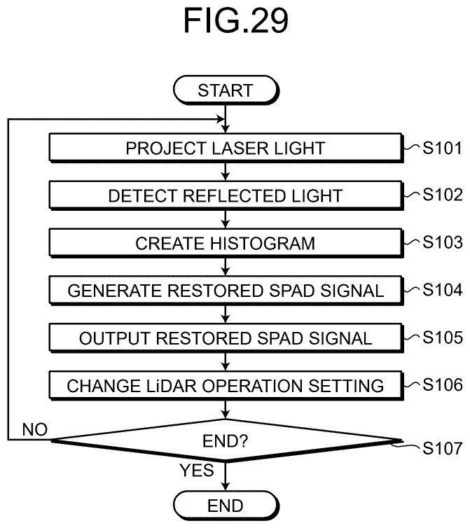

Next, a schematic operation flow of the ToF sensor 1 according to the present embodiment will be described. FIG. 29 is a flowchart illustrating a schematic flow example of the ToF sensor according to the present embodiment.

As illustrated in FIG. 29, in the present operation, first, the laser light L1 is projected from the light projecting section 13 at a predetermined light emission cycle (Step S101). On the other hand, in the light receiving section 14, the reflected light L2 is detected at a predetermined sampling period (Step S102), and the detected detection signal V_OUT is input to the signal integration section 103.

As described above, the signal integration section 103 counts the detection signal V_OUT input from the macro pixel 30 for each sampling period to generate the pixel value for each sampling period of each macro pixel 30, and integrates the generated pixel value with the value of the corresponding bin in the histogram to create the histogram (SPAD deterioration signal). (Step S103). The histogram (SPAD deterioration signal) thus created is input to the restoration section 105.

The restoration section 105 generates a restored SPAD signal having a waveform close to the laser waveform of the original reflected light L2 or substantially equal to the laser waveform of the original reflected light L2 on the basis of the histogram (SPAD deterioration signal) created in Step S103, the drive history of the light receiving section 14 input from the voltage control section 104, and the drive history and known characteristics input from the light projecting section 13 (Step S104). At that time, the restoration section 105 may generate the restoration accuracy as described above.

Next, the restored SPAD signal generated in Step S104 and the restoration accuracy are output (Step S105). At that time, the restored SPAD signal and/or the restoration accuracy may be compressed in the output section 106.

Furthermore, the signal integration section 103 may output a drive change request for adjusting (feedback control) the drive of the applied voltage (reverse bias voltage V_SPAD) and the like in the light receiving section 14 to the voltage control section 104 on the basis of the degree of deterioration such as a peak value and a half-value width of the SPAD deterioration signal created in Step S103, for example (Step S106).

Thereafter, for example, the control section 11 (see FIG. 1) determines whether or not to end the present operation (Step S107), and when it is ended (YES in Step S107), the present operation is ended. On the other hand, when the present operation is continued (NO in Step S107), the present operation returns to Step S101, and the subsequent operations are executed.

### 1.15 Summary

As described above, according to the present embodiment, it is possible to restore the laser waveform (restored SPAD signal) close to the original laser waveform or substantially equal to the original laser waveform from the SPAD deterioration signal in which the waveform is deteriorated, and thus, it is possible to suppress a decrease in the distance measurement accuracy.

Furthermore, according to the present embodiment, by adding the information (restoration accuracy) regarding the restoration accuracy to the restored SPAD signal, it is possible to execute processing according to the restoration accuracy in the processing of the subsequent stage, and thus it is possible to further suppress a decrease in the distance measurement accuracy.

### 1.16 Modification

Note that, in the above description, a case where the restoration section 105 includes the signal conversion section 1051, the SPAD state estimation section 1052, and the waveform restoration section 1053, and each of them operates according to a predetermined algorithm to restore the restored SPAD signal from the SPAD deterioration signal has been exemplified, but the present embodiment is not limited thereto, and various changes may be made, for example, a configuration of generating the restored SPAD signal using a machine learning algorithm such as a deep neural network (DNN).

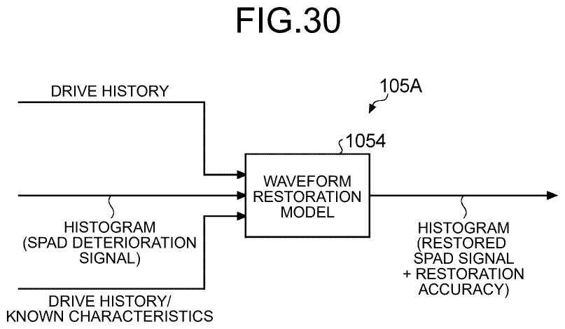

FIG. 30 is a block diagram illustrating a configuration example of a restoration section according to a modification of the present embodiment. As illustrated in FIG. 30, the restoration section 105A according to the modification may include, for example, a waveform restoration model 1054 that is a learned model learned to output a restored SPAD signal in response to an input of a SPAD deterioration signal. In addition to the restored SPAD signal, the waveform restoration model 1054 may be a learned model with multimodal support in which a drive history of the light receiving section 14, a drive history and/or a known characteristic of the light projecting section 13 can also be input.

The restoration section 10A may output a score when the waveform restoration model 1054 estimates the restored SPAD signal as the restoration accuracy. Note that the score is an index indicating the reliability of the restored SPAD signal that is an output, and may be, for example, a value calculated using an evaluation function.

### 2. Second Embodiment

Next, a second embodiment of the present disclosure will be described in detail below with reference to the drawings. Note that, in the following description, configurations, operations, and effects similar to those of the above-described embodiment or the modification thereof are cited, and redundant description is omitted.

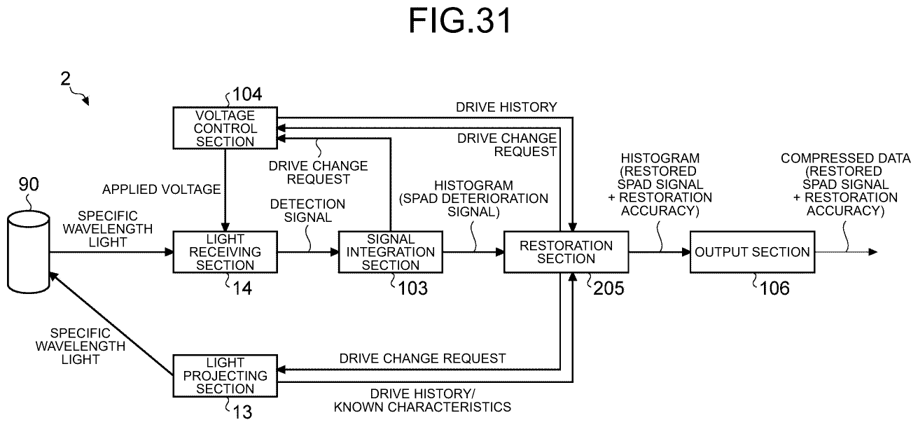

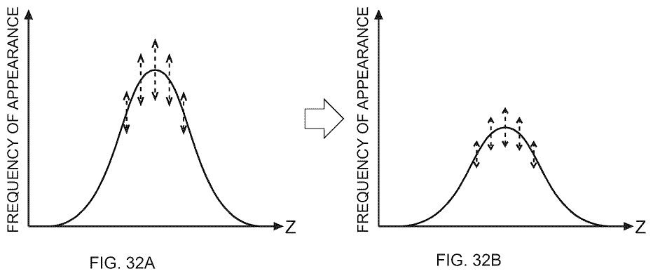

FIG. 31 is a block diagram illustrating a more detailed configuration example of the ToF sensor according to the present embodiment. Note that, in FIG. 31 and the following description, a part of the configuration of the ToF sensor 2 will be focused, similarly to the description of FIG. 16 in the first embodiment.

As illustrated in FIG. 31, in the ToF sensor 2, the restoration section 105 is replaced with the restoration section 205 in a configuration similar to that of the ToF sensor 1 described with reference to FIG. 16 in the first embodiment.

In the present embodiment, the restoration section 205 is configured to be able to output, to the voltage control section 104, a drive change request for adjusting (feedback control) the drive such as the applied voltage (reverse bias voltage V_SPAD) and the operation timing in the light receiving section 14. Furthermore, the restoration section 205 is configured to be able to output, to the light projecting section 13, a drive change request for adjusting (feedback control) the drive of the laser power, the emission timing, and the like of the laser light L1 emitted from the light projecting section 13.

As illustrated in (A) of FIG. 32, for example, in a case where the ratio of the SPAD pixels 20 saturated due to the influence of high luminance or the like is large, and thus the error range of the estimation error of the estimated SPAD signal to be estimated is large, as illustrated in (B), the ratio of the SPAD pixels 20 saturated may be reduced by adjusting the laser power of the laser light L1 and the light receiving sensitivity of the light receiving section 14, and the influence of saturation may be alleviated.

Therefore, in a case where the estimation accuracy obtained in estimating the estimated SPAD signal from the SPAD deterioration signal exceeds, for example, a preset upper limit value, the restoration section 205 outputs a drive change request for the light receiving section 14 and/or the light projecting section 13 to the voltage control section 104 or the light projecting section 13, thereby adjusting the laser power of the laser light L1 and/or the light receiving sensitivity of the light receiving section 14.

However, it is not limited to such an operation, and for example, in a case where the SPAD pixels 20 included in the SPAD array 37 are divided into two or more sets, and each set is driven under different conditions to generate separate histograms (SPAD deterioration signals), the restoration section 205 may generate a new estimated SPAD signal in which the influence of saturation or the like is reduced by complementing the SPAD deterioration signals or the estimated SPAD signals so as to connect data sections in better states from the SPAD deterioration signals generated in the respective sets or the estimated SPAD signals estimated therefrom. In that case, the estimation accuracy of the portion used for complementation in each estimated SPAD signal may be used for the estimation accuracy.

Note that the different conditions may be, for example, conditions such as a driving voltage of the light receiving section 14 and/or the light projecting section 13, a driving method (passive/active recharge method, synchronous/asynchronous recharge method, and the like) of the SPAD pixel 20, power, a waveform, and an emission timing of the laser light L1 emitted from the light projecting section 13.

Furthermore, also in a case where the SPAD deterioration signal or the estimated SPAD signal acquired in the previous frame is held, similarly, the restoration section 205 may generate a new estimated SPAD signal in which the influence such as saturation is reduced by complementing the SPAD deterioration signal or the estimated SPAD signal of the previous frame and the SPAD deterioration signal or the estimated SPAD signal of the current frame.

Other configurations, operations, and effects may be similar to those of the above-described embodiment or the modification thereof, and thus detailed description thereof is omitted here.

### 3. Third Embodiment

Next, a third embodiment of the present disclosure will be described in detail below with reference to the drawings. Note that, in the following description, configurations, operations, and effects similar to those of the above-described embodiment or the modification thereof are cited, and redundant description is omitted.

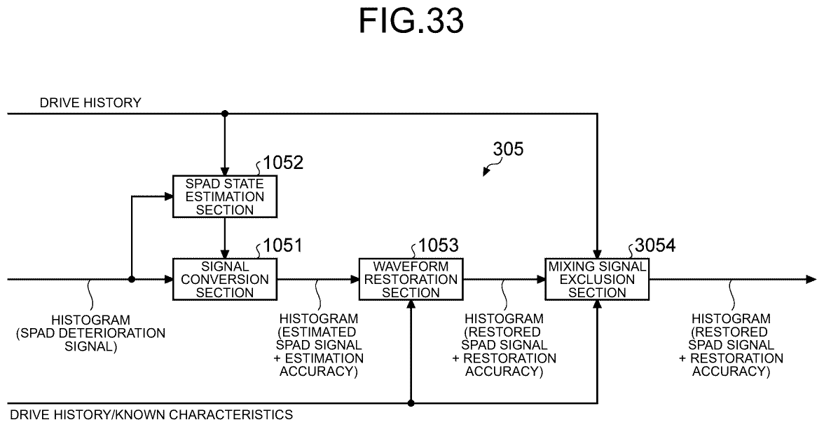

FIG. 33 is a block diagram illustrating a more detailed configuration example of the restoration section in the ToF sensor according to the present embodiment. Note that other configurations of the ToF sensor 2 according to the present embodiment may be similar to those of the above-described embodiment or the modification thereof.

As illustrated in FIG. 33, the restoration section 305 has, for example, a configuration in which a mixing signal exclusion section 3054 is added to an output stage of the waveform restoration section 1053 in a configuration similar to the restoration section 105 described with reference to FIG. 17 in the first embodiment.

For example, the mixing signal exclusion section 3054 removes components such as ambient light, flare, blur, and the like, and components reflected by rain, fog, and the like from the restored SPAD signal output from the waveform restoration section 1053. In the present description, components such as ambient light, flare, and blur, and components reflected by rain, fog, and the like are also collectively referred to as noise components.

For example, components such as ambient light, flare, and blur can be removed with high accuracy on the basis of the photon amount estimated by the signal conversion section 1051 (see, for example, Japanese Patent Application No. 2021-033442 and Japanese Patent Application No. 2021-038353).

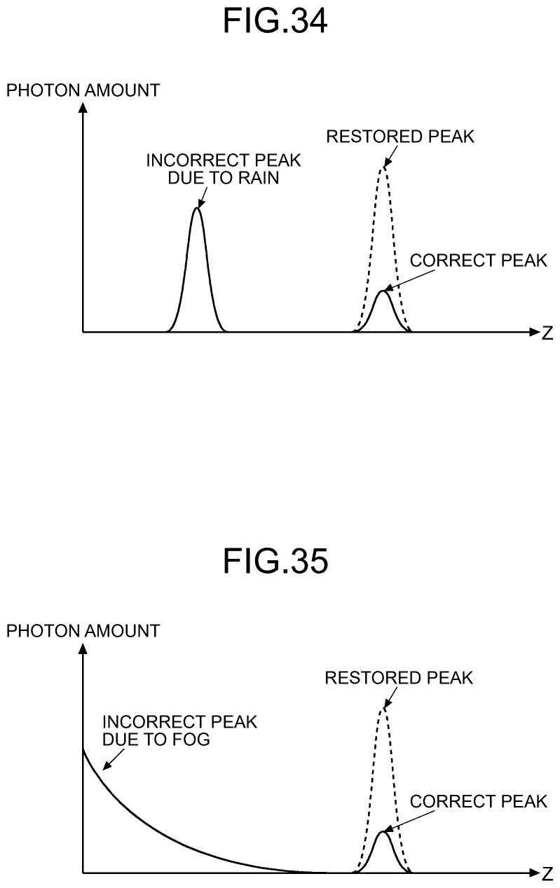

On the other hand, as illustrated in FIGS. 34 and 35, components reflected by rain, fog, and the like form a peak (hereinafter, also referred to as an incorrect peak) at a position before a peak (hereinafter, also referred to as a correct peak) of the reflected light L2 reflected by the object 90 to be measured in the SPAD signal (SPAD deterioration signal, estimated SPAD signal, or restored SPAD signal). Further, as a result of the laser light L1 being dissipated by reflection or scattering due to rain, fog, or the like, the light intensity (laser power) of the reflected light L2 reflected by the object 90 that is a subject becomes weak, and a peak value of the correct peak in the SPAD signal becomes low.

Accordingly, the mixing signal exclusion section 3054 may correct (restore) the power of the correct peak so as to approach the original value on the basis of an intensity value of the incorrect peak appearing before (for example, the peak value. Hereinafter, it is also referred to as power).

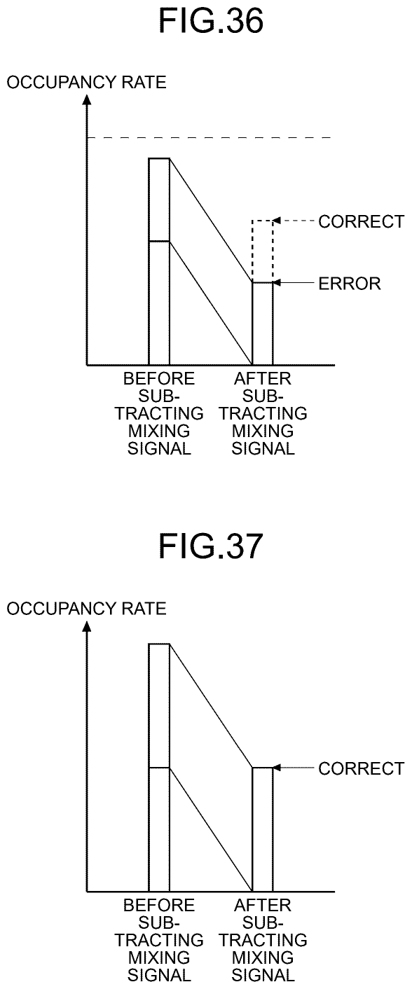

However, as described above with reference to FIG. 21, the occupancy rate x changes nonlinearly with respect to the photon amount c(x). Thus, as illustrated in FIG. 36, if the power of the correct peak is simply linearly increased or decreased (mixing signal subtraction) with the power of the incorrect peak while the occupancy rate x remains, the occupancy rate x after the mixed signal subtraction may become an incorrect value.

Therefore, as illustrated in FIG. 37, the mixing signal exclusion section 3054 converts the occupancy rate x of the correct peak into the photon amount c(x) before the mixing signal subtraction, and restores the power of the correct peak (mixing signal subtraction) on the basis of the power of the incorrect peak by using the converted photon amount c(x).

Note that, after the occupancy rate x is converted into the photon amount c(x), for example, the power of the correct peak can be restored with high accuracy on the basis of the power obtained from the photon amount c(x) according to the following Expression (11).
Subject position: z_{sig}
Power of correct peak (at time of input): Pₚₑₐₖ(z_{sig})
Laser power dissipated in front (position z): P_{scut}(z)

$$Sum total of dissipated laser power ( based on subject position ) : \\ {P}_{dec} ( {z}_{sig} ) = {\sum }_{z = {z}_{0}}^{{z}_{sig}} {p}_{deg} ( z ) \cdot {( \frac{z}{{z}_{sig}} )}^{2} \qquad ( 11 )$$

$$Original laser power at subject position : {P}_{sig} ( {z}_{sig} ) = {P}_{0} \cdot {( \frac{z}{{z}_{sig}} )}^{2}$$

$$Power of restored correct peak : \frac{{P}_{peak} ( {d}_{sig} ) \cdot {P}_{sig}}{{P}_{sig} - {P}_{dec}}$$

Other configurations, operations, and effects may be similar to those of the above-described embodiment or the modification thereof, and thus detailed description thereof is omitted here.

### 4. Hardware Configuration

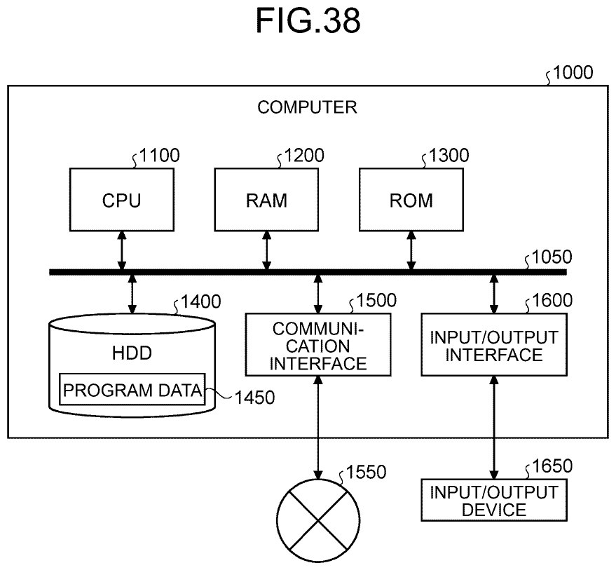

The control section 11 and/or the calculation section 15 according to the embodiment and the modification thereof described above can be implemented by the computer 1000 having a configuration as illustrated in FIG. 38, for example. FIG. 38 is a hardware configuration diagram illustrating an example of the computer 1000 that implements the functions of the control section 11 and/or the calculation section 15. The computer 1000 includes a CPU 1100, a RAM 1200, a read only memory (ROM) 1300, a hard disk drive (HDD) 1400, a communication interface 1500, and an input/output interface 1600. Each section of the computer 1000 is connected by a bus 1050.

The CPU 1100 operates on the basis of a program stored in the ROM 1300 or the HDD 1400, and controls each section. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records a program executed by the CPU 1100, data used by such a program, and the like. Specifically, the HDD 1400 is a recording medium that records a program for executing each operation according to the present disclosure which is an example of program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 has a configuration including the I/F section 18 described above, and is an interface for connecting the input/output device 1650 and the computer 1000. For example, the CPU 1100 receives data from an input device such as a keyboard and a mouse via the input/output interface 1600. Further, the CPU 1100 transmits data to an output device such as a display, a speaker, or a printer via the input/output interface 1600. Furthermore, the input/output interface 1600 may function as a media interface that reads a program or the like recorded in a predetermined recording medium. The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the control section 11 and/or the calculation section 15 according to the above-described embodiment, the CPU 1100 of the computer 1000 implements the functions of the control section 11 and/or the calculation section 15 by executing a program loaded on the RAM 1200. In addition, the HDD 1400 stores a program and the like according to the present disclosure. Note that the CPU 1100 reads the program data 1450 from the HDD 1400 and executes the program data 1450, but as another example, these programs may be acquired from another device via the external network 1550.

### 5. Application Example

A technology according to the present disclosure is applicable to various products. For example, the technology according to the present disclosure may be implemented as a device mounted on any type of mobile body such as an automobile, an electric vehicle, a hybrid electric vehicle, a motorcycle, a bicycle, a personal mobility, an airplane, a drone, a boat, a robot, a construction machine, an agricultural machine (tractor), and the like.

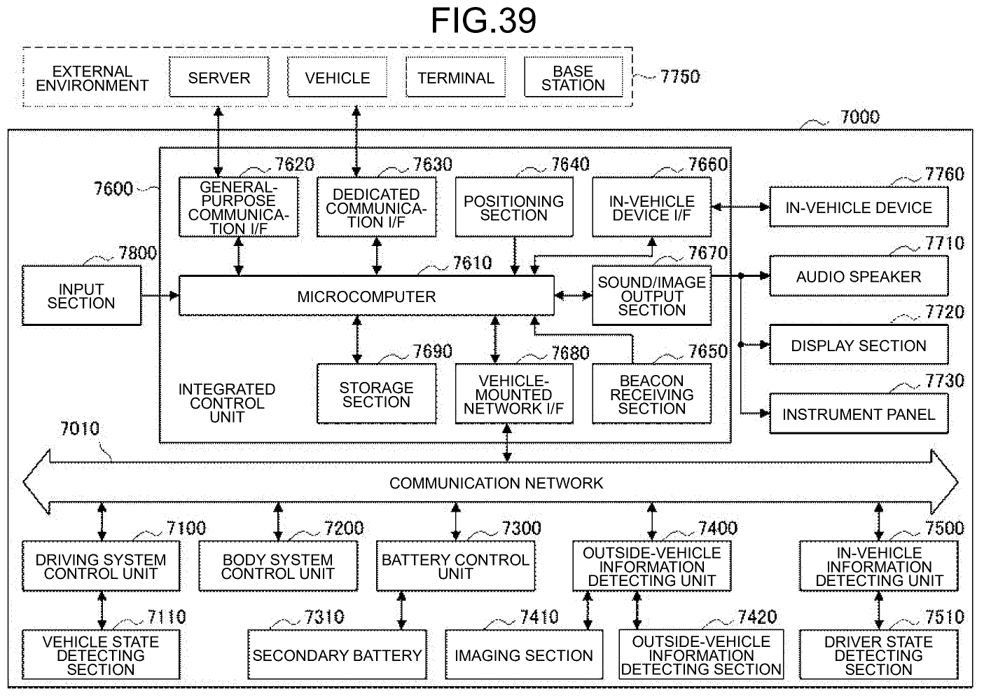

FIG. 39 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 39, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 39 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

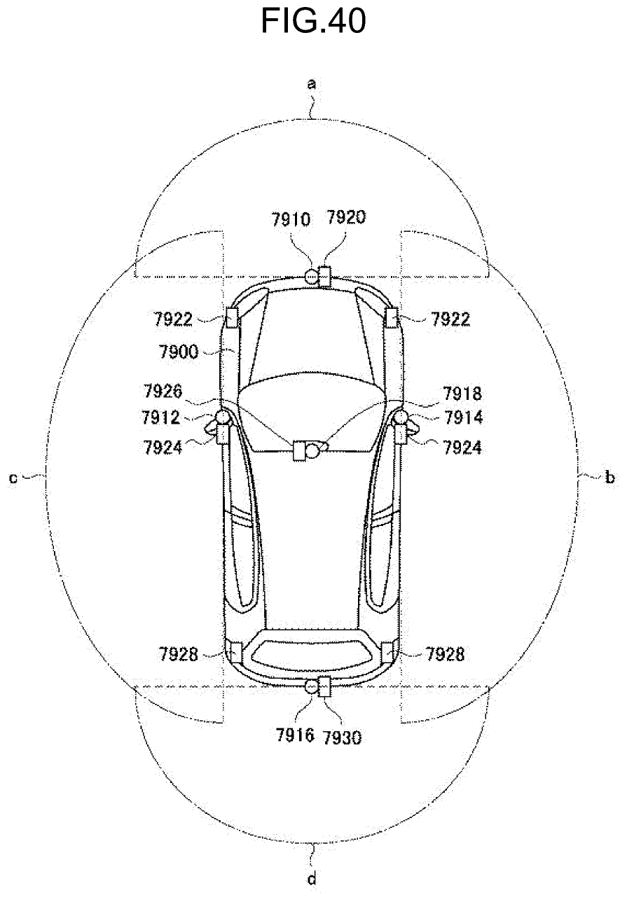

FIG. 40 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 40 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 39, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 39, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 39 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Note that a computer program for implementing each function of the control section 11 and/or the calculation section 15 according to the present embodiment described with reference to FIG. 1 can be mounted on any control unit or the like. Furthermore, it is also possible to provide a computer-readable recording medium storing such a computer program. The recording medium is, for example, a magnetic disk, an optical disk, a magneto-optical disk, a flash memory, or the like. In addition, the computer program described above may be distributed via, for example, a network without using the recording medium.

In the vehicle control system 7000 described above, the distance measuring device (ToF sensor) according to the above-described embodiment or modification can be applied to the outside-vehicle information detecting section 7420 and/or the driver state detecting section 7510 of the application example illustrated in FIG. 39. Thus, it is possible to measure the distance with higher accuracy, and thus it is possible to achieve safer driving support and automated driving.

Although the embodiments of the present disclosure have been described above, the technical scope of the present disclosure is not limited to the above-described embodiments as it is, and various modifications can be made without departing from the gist of the present disclosure. In addition, components of different embodiments and modification examples may be appropriately combined.

In addition, the effects in the embodiments described in the present description are merely examples and are not limited, and other effects may be provided.

Note that the present technology can also have the following configurations.

(1)

A distance measuring device comprising:
a light projecting section that emits pulsed irradiation light;
a light receiving section in which a plurality of pixels each detecting incidence of a photon is arranged;
an integration section that creates a first histogram for each of the pixels by using a detection signal output from each of the pixels; and
a restoration section that converts the first histogram into a second histogram on a basis of a state of the light receiving section.
   (2)

The distance measuring device according to (1), wherein
the restoration section generates accuracy information when the first histogram is converted into the second histogram.
   (3)

The distance measuring device according to (2), wherein
the accuracy information includes at least one of a quantization error or a standard deviation.
   (4)

The distance measuring device according to any one of (1) to (3), wherein
the restoration section converts the first histogram into the second histogram by converting a value of each bin in the first histogram on a basis of a relationship between a ratio of pixels in a dead period in the light receiving section and a number of photons estimated to be incident on each of the pixels.
   (5)

The distance measuring device according to any one of (1) to (4), wherein
the restoration section estimates at least one of a ratio of pixels in a dead period in the light receiving section or sensitivity to photon incidence of each of the pixels as a state of the light receiving section.
   (6)

The distance measuring device according to (5), wherein
the restoration section estimates at least one of the ratio of pixels in a dead period or the sensitivity to photon incidence of each of the pixels on a basis of a drive history of the light receiving section.
   (7)

The distance measuring device according to (6), wherein
the drive history of the light receiving section includes at least one of a driving voltage applied to each of the pixels or a timing at which the driving voltage is applied to each of the pixels.
   (8)

The distance measuring device according to any one of (1) to (7), wherein
the restoration section corrects a value of each bin in the second histogram on a basis of at least one of a drive history or a known characteristic of the light projecting section.
   (9)

The distance measuring device according to (8), wherein
the restoration section corrects the value of each bin in the second histogram by using a least squares method so that a waveform of the second histogram becomes close to a laser waveform of the irradiation light.
   (10)

The distance measuring device according to (8) or (9), wherein
the drive history of the light projecting section includes at least one of laser power of the irradiation light or an emission timing of the irradiation light, and
the known characteristic of the light projecting section includes at least one of a peak intensity of the irradiation light, a laser waveform of the irradiation light, or a wavelength spectrum of the irradiation light.
   (11)

The distance measuring device according to any one of (1) to (10), further comprising:
a compression section that compresses the second histogram.
   (12)

The distance measuring device according to (11), wherein
the compression section compresses the second histogram to a feature amount of the second histogram by extracting the feature amount of the second histogram or compresses the second histogram by bit-reducing a value of each bin of the second histogram.
   (13)

The distance measuring device according to any one of (1) to (12), wherein
the plurality of pixels is divided into two or more sets including a first set and a second set, and
the restoration section generates a third histogram by partially connecting a first histogram created for a pixel belonging to the first set and a first histogram created for a pixel belonging to the second set, and converts the third histogram into the second histogram on a basis of a state of the light receiving section.
   (14)

The distance measuring device according to (13), wherein
a pixel belonging to the first set and a pixel belonging to the second set are driven under a condition that at least one of a driving voltage to be applied, a driving method, power of the irradiation light, a waveform of the irradiation light, or an emission timing of the irradiation light is different.
   (15)

The distance measuring device according to any one of (1) to (14), further comprising:
an exclusion section that removes a noise component from the second histogram.
   (16)

The distance measuring device according to (15), wherein
the exclusion section removes the noise component by correcting a value of a correct peak on a basis of a value of an incorrect peak located before the correct peak by the reflected light from a subject in the second histogram.
   (17)

The distance measuring device according to (2) or (3), wherein
the restoration section outputs a drive change request for changing drive of at least one of the light projecting section or the light receiving section on a basis of the accuracy information.
   (18)

The distance measuring device according to (1), wherein
the restoration section includes a learned model learned to output the second histogram using at least the first histogram as an input.
   (19)

A distance measuring method in a distance measuring device including a light projecting section that emits pulsed irradiation light and a light receiving section in which a plurality of pixels each detecting incidence of a photon is arranged, the method comprising:
creating a first histogram for each of the pixels by using a detection signal output from each of the pixels; and
converting the first histogram into a second histogram on a basis of a state of the light receiving section.
   (20)

A recording medium recording a program for causing a processor mounted on a distance measuring device including a light projecting section that emits pulsed irradiation light and a light receiving section in which a plurality of pixels each detecting incidence of a photon is arranged to function, the program being for causing the processor to execute:
a step of creating a first histogram for each of the pixels by using a detection signal output from each of the pixels; and
a step of converting the first histogram into a second histogram on a basis of a state of the light receiving section.

### REFERENCE SIGNS LIST

1 DISTANCE MEASURING DEVICE (TOF SENSOR)
11 CONTROL SECTION
13 LIGHT PROJECTING SECTION
14 LIGHT RECEIVING SECTION
15 CALCULATION SECTION
19 EXTERNAL I/F
20 SPAD PIXEL
20A EFFECTIVE SPAD PIXEL
20B DEAD SPAD PIXEL
21 PHOTODIODE
22 READOUT CIRCUIT
23 QUENCH RESISTOR
24 SELECTION TRANSISTOR
25 DIGITAL CONVERTER
25a RESISTOR
25b, 26b NMOS TRANSISTOR
26 INVERTER
26a PMOS TRANSISTOR
27 BUFFER
30 MACRO PIXEL
31 LIGHT SOURCE
32 COLLIMATOR LENS
33 HALF MIRROR
34 DRIVE SECTION
35 GALVANO MIRROR
36 LIGHT RECEIVING SENSOR
37 SPAD ARRAY
37-1 to 37-4 SPAD REGION
38 LIGHT RECEIVING LENS
43 TIMING CONTROL CIRCUIT
44 DRIVE CIRCUIT
45 OUTPUT CIRCUIT
50 SPAD ADDITION SECTION
51 PULSE SHAPING SECTION
52 LIGHT RECEPTION NUMBER COUNTING SECTION
80 HOST
103 SIGNAL INTEGRATION SECTION
104 VOLTAGE CONTROL SECTION
105, 205, 305 RESTORATION SECTION
106 OUTPUT SECTION
1051 SIGNAL CONVERSION SECTION
1052 SPAD STATE ESTIMATION SECTION
1053 WAVEFORM RESTORATION SECTION
1054 WAVEFORM RESTORATION MODEL
1061 WAVEFORM FEATURE AMOUNT OUTPUT SECTION
1062 HISTOGRAM COMPRESSION SECTION
3054 MIXING SIGNAL EXCLUSION SECTION

1. A distance measuring device comprising:
a light projecting section that emits pulsed irradiation light;
a light receiving section in which a plurality of pixels each detecting incidence of a photon is arranged;
an integration section that creates a first histogram for each of the pixels by using a detection signal output from each of the pixels; and
a restoration section that converts the first histogram into a second histogram on a basis of a state of the light receiving section.

2. The distance measuring device according to claim 1, wherein
the restoration section generates accuracy information when the first histogram is converted into the second histogram.

3. The distance measuring device according to claim 2, wherein
the accuracy information includes at least one of a quantization error or a standard deviation.

4. The distance measuring device according to claim 1, wherein
the restoration section converts the first histogram into the second histogram by converting a value of each bin in the first histogram on a basis of a relationship between a ratio of pixels in a dead period in the light receiving section and a number of photons estimated to be incident on each of the pixels.

5. The distance measuring device according to claim 1, wherein
the restoration section estimates at least one of a ratio of pixels in a dead period in the light receiving section or sensitivity to photon incidence of each of the pixels as a state of the light receiving section.

6. The distance measuring device according to claim 5, wherein
the restoration section estimates at least one of the ratio of pixels in a dead period or the sensitivity to photon incidence of each of the pixels on a basis of a drive history of the light receiving section.

7. The distance measuring device according to claim 6, wherein
the drive history of the light receiving section includes at least one of a driving voltage applied to each of the pixels or a timing at which the driving voltage is applied to each of the pixels.

8. The distance measuring device according to claim 1, wherein
the restoration section corrects a value of each bin in the second histogram on a basis of at least one of a drive history or a known characteristic of the light projecting section.

9. The distance measuring device according to claim 8, wherein
the restoration section corrects the value of each bin in the second histogram by using a least squares method so that a waveform of the second histogram becomes close to a laser waveform of the irradiation light.

10. The distance measuring device according to claim 8, wherein
the drive history of the light projecting section includes at least one of laser power of the irradiation light or an emission timing of the irradiation light, and
the known characteristic of the light projecting section includes at least one of a peak intensity of the irradiation light, a laser waveform of the irradiation light, or a wavelength spectrum of the irradiation light.

11. The distance measuring device according to claim 1, further comprising:
a compression section that compresses the second histogram.

12. The distance measuring device according to claim 11, wherein
the compression section compresses the second histogram to a feature amount of the second histogram by extracting the feature amount of the second histogram or compresses the second histogram by bit-reducing a value of each bin of the second histogram.

13. The distance measuring device according to claim 1, wherein
the plurality of pixels is divided into two or more sets including a first set and a second set, and
the restoration section generates a third histogram by partially connecting a first histogram created for a pixel belonging to the first set and a first histogram created for a pixel belonging to the second set, and converts the third histogram into the second histogram on a basis of a state of the light receiving section.

14. The distance measuring device according to claim 13, wherein
a pixel belonging to the first set and a pixel belonging to the second set are driven under a condition that at least one of a driving voltage to be applied, a driving method, power of the irradiation light, a waveform of the irradiation light, or an emission timing of the irradiation light is different.

15. The distance measuring device according to claim 1, further comprising:
an exclusion section that removes a noise component from the second histogram.

16. The distance measuring device according to claim 15, wherein
the exclusion section removes the noise component by correcting a value of a correct peak on a basis of a value of an incorrect peak located before the correct peak by the reflected light from a subject in the second histogram.

17. The distance measuring device according to claim 2, wherein
the restoration section outputs a drive change request for changing drive of at least one of the light projecting section or the light receiving section on a basis of the accuracy information.

18. The distance measuring device according to claim 1, wherein
the restoration section includes a learned model learned to output the second histogram using at least the first histogram as an input.

19. A distance measuring method in a distance measuring device including a light projecting section that emits pulsed irradiation light and a light receiving section in which a plurality of pixels each detecting incidence of a photon is arranged, the method comprising:
creating a first histogram for each of the pixels by using a detection signal output from each of the pixels; and
converting the first histogram into a second histogram on a basis of a state of the light receiving section.

20. A recording medium recording a program for causing a processor mounted on a distance measuring device including a light projecting section that emits pulsed irradiation light and a light receiving section in which a plurality of pixels each detecting incidence of a photon is arranged to function, the program being for causing the processor to execute:
a step of creating a first histogram for each of the pixels by using a detection signal output from each of the pixels; and
a step of converting the first histogram into a second histogram on a basis of a state of the light receiving section.
